(19) United States
(12) Patent Application Publication
(10) Pub. No.: US 2012/0229376 A1
(43) Pub. Date: Sep. 13, 2012

(54) INPUT DEVICE

(76) Inventors: Atsushi Matsumoto, Tokyo (JP); Wataru Yamazaki, Tokyo (JP); Takuji Morimoto, Tokyo (JP); Taro Kumagai, Tokyo (JP)

(21) Appl. No.: 13/508,259

(22) PCT Filed: Jan. 18, 2010
(86) PCT No.: PCT/JP2010/000234

§ 371 Date: May 4, 2012

(51) Int. Cl. G09G 5/00

(52) U.S. Cl. 345/156

(57) ABSTRACT

An input device displays a screen including character input buttons to each of which characters are assigned, and each of which specifies one character assigned thereto, as a character to be inputted, according to the number of times that a selection operation is performed thereon, and display area B in which a character to be inputted specified through a selection operation performed on the character input buttons is displayed in order on a display device, specifies candidate characters each of which can be inputted to follow a character string being inputted and displayed in the display area B from the character strings of words each including the character string being inputted, and, when a character to be inputted which is specified to follow the character string is not included in the candidate characters, tones down and displays the character to be inputted immediately after the character string.

### FIELD OF THE INVENTION

The present invention relates to an input device which performs a character input on an information processing device, such as a car navigation system.

### BACKGROUND OF THE INVENTION

As a conventional input device for use in a car navigation system, for example, there is an input device with which, when setting up a destination by using a route guidance function, the user performs an input using the 50 Japanese phonetic characters to input and set the name of the destination to the car navigation system. In the input using the 50 Japanese phonetic characters, a list of characters to be inputted (a Japanese kana syllabary table) is displayed on a display device. By using a touch panel or the like, the user selects the characters which constructs the name of the destination one by one in the order that they appear in the name from the list of characters to be inputted to input the characters to the car navigation system.

Further, when the user performs an input using the 50 Japanese phonetic characters, the conventional input device searches through a dictionary database for character strings each including the character string inputted by the user, and usually displays only candidate characters which can follow the already inputted character string on the display device. In contrast, the other characters are determined not to fall within the target for input, and the display colors of the other characters are toned down or the display of the other characters is omitted (for example, refer to patent references 1 to 4).

Patent reference 5 describes an input device which selects and inputs characters one by one from a one-dimensional character list display area. This input device displays only characters which can follow the character string inputted by the user while omitting the display of the other characters. By doing in this way, the input device makes it easy for the user to perform the character input operation.

In any of conventional input devices, there is a one-to-one correspondence between a certain character button and a character which can be inputted using this button. More specifically, the user is allowed to select (push down) a button for character input which is displayed on the screen of a display device to input the character displayed on this button.

In contrast, in accordance with a character input method for use in mobile telephone terminals and so on, a plurality of characters are assigned to each button for character input displayed on a display device, and switching among the characters assigned to each button in order is performed to display one of them on the display device every time when this button is pushed down.

Because a software keyboard (referred to as an S/W keyboard from here on) which enables such an input does not have a one-to-one correspondence between each button for character input and a character which is inputted when this button is pushed down, buttons for character input corresponding to characters other than candidate characters which can follow the character string being inputted cannot be toned down or the display of the other characters cannot be omitted even if any of the techniques described in patent references 1 to 5 is applied.

The present invention is made in order to solve the above-mentioned problem, and it is therefore an object of the present invention to provide an input device which can facilitate a character input operation in an S/W keyboard in which a plurality of characters are assigned to each of buttons for character input, and switching among the plurality of characters assigned to each button in order is carried out in such a way that each of them is displayed in the order while being selectable by the user every time when the user selects the button.

### RELATED ART DOCUMENT

### Patent Reference

Patent reference 1: Japanese Unexamined Patent Application Publication No. JP-A 9-160910,
Patent reference 2: Japanese Unexamined Patent Application Publication No. JP-A 11-272386,
Patent reference 3: Japanese Unexamined Patent Application Publication No. JP-A 2001-50768,
Patent reference 4: Japanese Unexamined Patent Application Publication No. JP-A 2005-44220,
Patent reference 5: Japanese Unexamined Patent Application Publication No. JP-A 2008-90794,

### SUMMARY OF THE INVENTION

In accordance with the present invention, there is provided an input device including: a display unit for displaying a screen for character input including a plurality of character input buttons to each of which a plurality of characters are assigned, and each of which specifies one of the characters assigned thereto, as a character to be inputted, according to a number of times that a selection operation is performed thereon, and an input character string display area in which a character to be inputted which is specified through a selection operation performed on the plurality of character input buttons is displayed in order; an operation unit for performing a selection operation on the plurality of character input buttons; a searching unit for searching through the database stored in a storage unit on a basis of a character or a character string being inputted and displayed in the input character string display area to extract character strings of words each including the character or the character string being inputted, and for specifying candidate characters each of which can be inputted so as to follow the character or the character string being inputted from the extracted character strings; and a display control unit for controlling a display operation of the display unit, and, when a character to be inputted which is specified to follow the character or the character string being inputted and displayed in the input character string display area is not included in the candidate characters specified by the searching unit, toning down and displaying the character to be inputted immediately after the character or the character string being inputted and displayed in the input character string display area.

The input device in accordance with the present invention displays the screen for character input including the plurality of character input buttons to each of which a plurality of characters are assigned, and each of which specifies one of the characters assigned thereto, as a character to be inputted, according to the number of times that a selection operation is performed thereon, and the input character string display area in which a character to be inputted which is specified through a selection operation performed on the character input buttons is displayed in order on the display unit, specifies the candidate characters each of which can be inputted so as to follow the character or the character string being inputted and displayed in the input character string display area from the character strings of words each including the character or the character string being inputted, and, when a character to be inputted which is specified to follow the character or the character string being inputted and displayed in the input character string display area is not included in the candidate characters, tones down and displays the character to be inputted immediately after the character or the character string being inputted and displayed in the input character string display area.

The input device tones down and displays the character to be inputted immediately after the character or the character string being inputted and displayed in the input character string display area in this way when the character to be inputted which is inputted to follow the character or the character string being inputted and displayed in the input character string display area is not included in the candidate characters each of which can be inputted so as to follow the character or the character string being inputted. Therefore, there is provided an advantage of improving the visibility of any character which can be inputted, and facilitating the operation of inputting a character.

### BRIEF DESCRIPTION OF THE FIGURES

FIG. 1 is a block diagram showing the structure of a car navigation device to which an input device in accordance with Embodiment 1 of the present invention is applied;

FIG. 2 is a block diagram showing the structure of the input device in accordance with Embodiment 1;

FIG. 3 is a view showing an example of a screen for character input in accordance with Embodiment 1;

FIG. 4 is a view showing a relationship between each character input button of the input device in accordance with Embodiment 1 and characters assigned to this character input button;

FIG. 5 is a flow chart showing a flow of the operation of the input device in accordance with Embodiment 1;

FIG. 6 is a view showing a display example of a screen for character input according to a character input operation in the input device in accordance with Embodiment 1;

FIG. 7 is a flow chart showing a flow of the operation of an input device in accordance with Embodiment 2 of the present invention;

FIG. 8 is a view showing a display example of a screen for character input according to a character input operation in the input device in accordance with Embodiment 2;

FIG. 9 is a view showing an example of a screen for character input of the input device in accordance with Embodiment 3;

FIG. 10 is a view showing a relationship between each character input button of the input device in accordance with Embodiment 3 and characters assigned to this character input button;

FIG. 11 is a view showing a display example of a screen for character input according to a character input operation in the input device in accordance with Embodiment 3;

FIG. 12 is a view showing an example of a screen for character input of an input device in accordance with Embodiment 4; and

FIG. 13 is a view showing a display example of a screen for character input according to a character input operation in the input device in accordance with Embodiment 4.

### EMBODIMENTS OF THE INVENTION

Hereafter, in order to explain this invention in greater detail, the preferred embodiments of the present invention will be described with reference to the accompanying drawings. Embodiment 1.

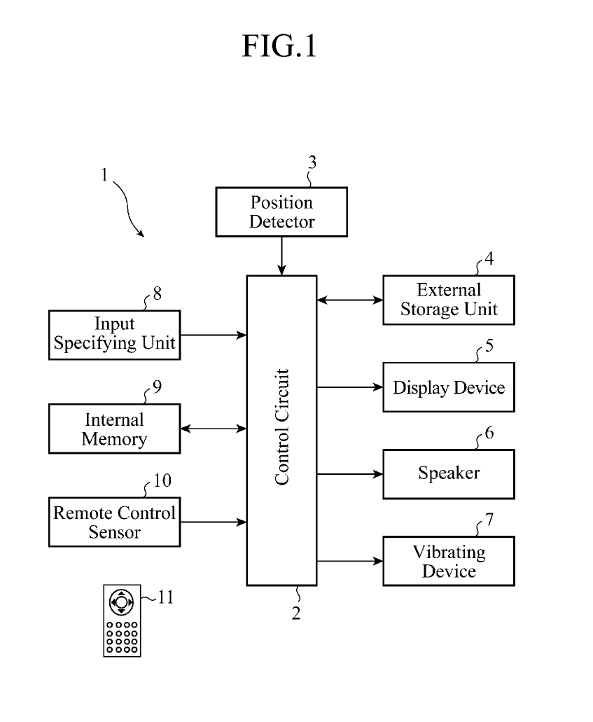

FIG. 1 is a block diagram showing the structure of a car navigation device to which an input device in accordance with Embodiment 1 of the present invention is applied. The car navigation device 1 shown in FIG. 1 is provided with a control circuit 2, a position detector 3, an external storage unit (storage unit) 4, a display device (display device) 5, a speaker 6 for sound output (sound output unit), a vibrating device (vibrating device unit) 7, an input specifying device 8, an internal memory 9, a remote control sensor 10, a remote control terminal 11 (abbreviated as a remote control 11 from here on), and so on.

The control circuit 2 controls the operation of the car navigation device 1 which employs the above-mentioned components, and is comprised of an arithmetic processing circuit including a CPU, a ROM, a RAM, an I/O interface unit, and so on which are mounted in a microcomputer of the car navigation device 1.

The position detector 3 detects the current position of a vehicle equipped with the car navigation device 1 (referred to as a self-vehicle from here on), and so on. For example, the position detector 3 is constructed in such a way as to be connected to a GPS (Global Positioning System) receiver, a gyro sensor, a G sensor, and so on, which are not shown in FIG. 1, and detects the current position and the traveling direction of the self-vehicle according to output signals from the GPS receiver, the gyro sensor, the G sensor, and so on with a high degree of accuracy.

The external storage unit 4 stores road map data used for navigation processing, destination data accompanying the road map data, and dictionary data consisting of a large number of words including the names of destinations, such as facility names, and functions as a database in which these data are registered.

This external storage unit 4 can be constructed by using a storage medium, such as a CD, a DVD, or a hard disk, and a drive device for driving the storage medium, or a USB memory. As an alternative, the external storage unit 4 can be constructed in a storage unit disposed in another computer which can communicate with the car navigation device 1.

Further, the road map data are constructed in such away as to include data about road geometries, road widths, road names, buildings, various facilities, the names of places, geographical features, etc., and also include data used for reproducing a road map on the screen of the display device 5 which will be mentioned later.

The destination data are constructed in such a way as to include information about facilities, such as transport facilities including stations, leisure facilities, lodging facilities, and public facilities, and information about various stores, such as retail stores and department stores, restaurants, residences, apartments, the names of places, and so on. The destination data further include data about the address, the telephone number, the latitude and longitude of each of these facilities, stores, and so on, and also include data used for superimposing a landmark or the like showing each facility on the top of a road map displayed on the screen of the display device 5.

The display device 5 displays various process results acquired by the control circuit 2 on the screen, and is constructed of, for example, a TFT (Thin Film Transistor) color liquid crystal display. As the car navigation device 1, a car navigation device whose display device 5 has a relatively small screen (for example, 5 inches) has become widespread. On this display device 5, the input device displays a navigation screen including a road map of an area surrounding the current position of the self-vehicle, and a character input screen used for input of the name of a destination, which will be mentioned later with reference to FIG. 3.

The speaker 6 outputs a sound from the car navigation device 1 to outside the car navigation device. For example, the speaker 6 outputs voice guidance about a route to the destination at the time when the car navigation device performs a location function, and produces an operation sound according to an operation on the input specifying device 8 and an operation sound according to an operation on the remote control 11.

The vibrating device 7 is a component which, when the input specifying device 8 is operated by an operator, vibrates to provide the operator with a feeling of operating the input specifying device. For example, in a case in which the input specifying device 8 is implemented by a touch panel, every time when the touch panel is touched by the operator, the vibrating device 7 vibrates to provide the operator with a feeling of touching the touch panel.

The input specifying device 8 inputs information from outside the car navigation device 1 to this car navigation device. For example, the input specifying device consists of a mouse, a slide pad using an infrared sensing method, or a touch panel. The input specifying device 8 also constructs a GUI (Graphical User Interface) via which the operator is allowed to input information according to a screen for information input which is displayed on the display device 5. The screen for information input includes a display screen of an S/W keyboard used for character input. The operator is allowed to move a pointer to the position of a desired button among a plurality of buttons displayed in the S/W keyboard and then perform a selection operation on the desired button by using the input specifying device 8 to input a character assigned to the selected button in the input device. Hereafter, an explanation will be made assuming that the input specifying device 8 is a touch panel.

In the internal memory 9, a program for processing executed by the CPU of the control circuit 2 is stored, and data used for information processing including the navigation processing is deployed. For example, road map data read from the external storage unit 4 is deployed in the internal memory 9, and is provided for a process which is carried out by the control circuit 2. The remote control sensor 10 detects a signal which is outputted by the remote control 11 according to an operation performed on the remote control 11, and an infrared sensor or the like is used as the remote control sensor. The remote control 11 is a unit for inputting information to the input device from outside the car navigation device 1, and is provided with a plurality of keys for information input. This remote control 11 and the input specifying device 8 function as an operation unit.

The control circuit 2 implements the location function of notifying the current position of the self-vehicle to the user, and a route guidance function of searching for a route to a destination specified by the user to provide route guidance for the user by executing the program for the navigation processing which is deployed in the internal memory 9.

In the location function, the car navigation device displays a road map on the display device 5 according to the road map data acquired from the external storage unit 4 (or the internal memory 9), and also superimposes and displays a current position mark showing the current position and the traveling direction of the self-vehicle according to the detection result acquired by the position detector 3 on the top of the road map.

Further, in the route guidance function, the car navigation device searches for a recommended route-to-be-traveled (route) from the place of departure (current position) of the self-vehicle to the destination specified by the user, and provides route guidance about the determined route-to-be-traveled for the user. In this route guidance, the car navigation device displays the route-to-be-traveled in a noticeable color on the display device 5 in addition to the above-mentioned road map and the above-mentioned current position mark of the self-vehicle, and also outputs a guiding voice from the speaker 6 at a predetermined time in combination with the display of the route-to-be-traveled.

On the other hand, in the route guidance function, there is provided a mode in which the user is allowed to set up a destination by inputting characters representing the name of his or her destination. In this character input mode, the control circuit 2 functions as the input device in accordance with Embodiment 1 of the present invention, and displays the screen for character input on the display device 5 to accept a character selection operation which is performed on the input specifying device 8 (or the remote control 11). Through an operation which is performed on the input specifying device 8 or the remote control 11, characters constructing the name of the destination are selectively inputted one by one in turn.

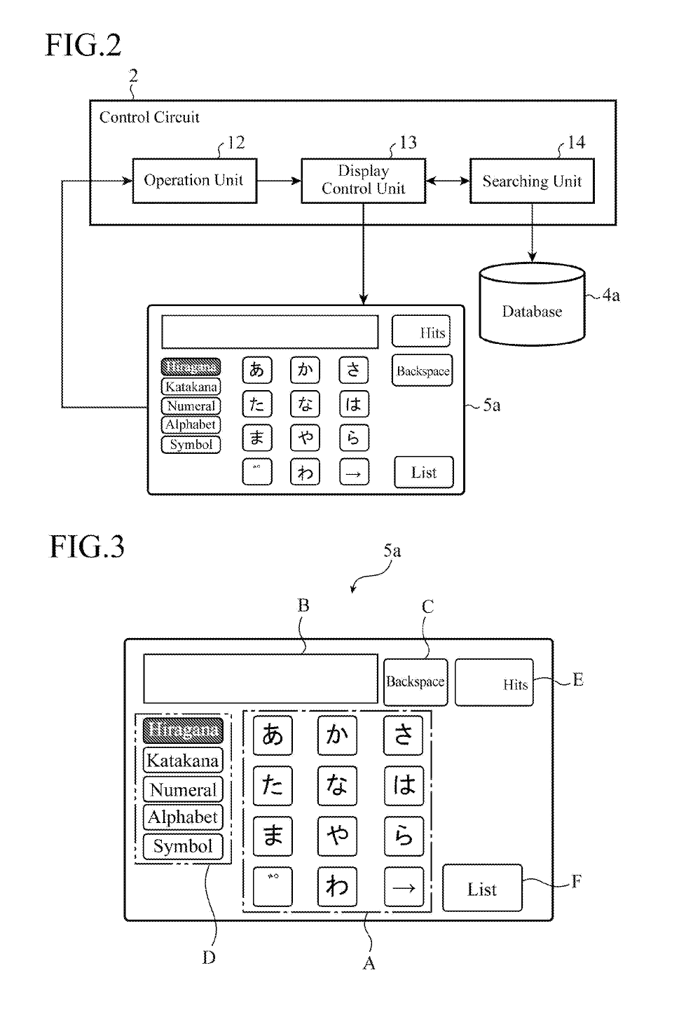

FIG. 2 is a block diagram showing the structure of the input device in accordance with Embodiment 1, and shows the configuration of functions of the input device which are configured in the control circuit 2 shown in FIG. 1. Referring to FIG. 2, the control circuit 2 is provided with an operation unit 12, a display control unit 13, and a searching unit 14 as the function configuration of the input device.

The operation unit 12 is a component for accepting an operation using the input specifying device 8 or the remote control 11 shown in FIG. 1 to determine a character which is selected through the operation.

The display control unit 13 is a component for controlling the screen display on the display device 5 to change the display of each button for character input according to whether or not a character to be inputted is included in candidate characters each of which can be inputted so as to follow a character string already inputted.

The searching unit 14 is a component for searching through the database 4a on the basis of the character string being inputted to extract words each including the character string being inputted, and for specifying candidate characters each of which can be inputted so as to follow the character string being inputted from the character strings of the extracted words.

In the database 4a, dictionary data consisting of a large number of words including the names of destinations, such as facility names, are registered. The database 4a is constructed in the external storage unit 4 shown in FIG. 1.

The screen for character input 5a is displayed on the display device 5, and is constructed in such a way as to include the S/W keyboard in which a plurality of characters are assigned to each of the buttons for character input, and switching among the plurality of characters assigned to each button in order is done in such a way that each of them is displayed in the order every time when the button is pushed down. The details of the screen for character input 5a will be mentioned later with reference to FIG. 3.

The operation unit 12, the display control unit 13, and the searching unit 14 can be implemented as a concrete means in which software and hardware work in cooperation with each other in the microcomputer by causing the CPU in the above-mentioned microcomputer of the navigation device 1 to execute a program for the character input processing according to the scope of the present invention.

FIG. 3 is a view showing an example of the screen for character input. In the screen for character input 5a shown in FIG. 3, a character input button display area A, an input character string display area B, a backspace button C, an input mode switching button D, a hit number display area E, and a facility list display button F are disposed.

In the character input button display area A, buttons each for enabling the user to select a character to be inputted (referred to as character input buttons from here on) are displayed.

When the input mode is a hiragana input one, a character input button group representing characters ( [symbol] (a), [symbol] (ka), [symbol] (sa), [symbol] (ta), [symbol] (n), [symbol] (ha), [symbol] (ma), [symbol] (ya), [symbol] (ra), [symbol] (wa)) in [symbol] (a) row in all columns of the Japanese hiragana table is displayed.

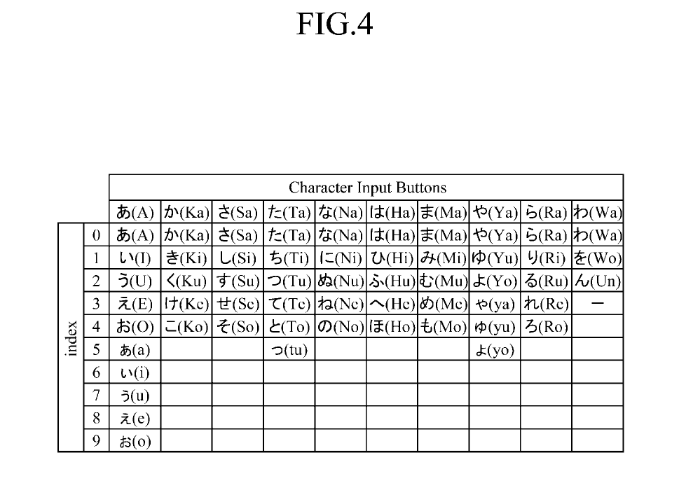

The hiragana characters of a corresponding column of the Japanese hiragana table are assigned to each character input button, as will be mentioned below in FIG. 4. Every time when the user selects (pushes down) each character input button, the character to be inputted changes in the following order: “hiragana character in [symbol] (a) row hiragana character in [symbol] (i) row→hiragana character in [symbol] (u) row→hiragana character in [symbol] e) row . . . ”. For example, in a case of inputting “ [symbol] (mie)”, the user can input this word by selecting the character input button associated with [symbol] (ma) column twice and then selecting the character input button associated with [symbol] (a) column four times.

Further, a “ [symbol] ” button is used when the user converts a Japanese syllabary character which the user has inputted immediately before pushing down this button into the b or p sound in the kana syllabary. A “→” button is used when the user determines an input of the first character in order to continuously input characters assigned to the same button. For example, when inputting “ [symbol] (ai)”, the user can input this word by selecting the “→” button after selecting the character input button associated with [symbol] (a) column, and further selecting the character input button associated with [symbol] (a) column twice.

In the example shown in FIG. 4, although “ [symbol] ” which is a hiragana small character is assigned to the character input button associated with [symbol] (a) column, this small character can be alternatively inputted as follows.

For example, a function of converting a hiragana character into a hiragana small character is provided for the “ [symbol] ” button, and, when inputting “ [symbol] ” which is a hiragana small character, the user can input “ [symbol] ” which is a hiragana small character by selecting the “ [symbol] ” button after selecting the character input button associated with [symbol] (a) column.

The input character string display area B is the one in which the input device displays characters which the user is currently inputting by performing an operation using the input specifying device 8 or the remote control 11. The characters being inputted which the user has selected are displayed in this input character string display area B one by one.

The backspace button C is used for allowing the user to delete a character displayed in the input character string display area B. By pushing down this backspace button C, the user can delete the character at the end of the character string currently being displayed in the input character string display area B.

The input mode switching button D is used for allowing the user to select the type of a character to be inputted. When one of various input modes is selected, the character representation of the character input buttons displayed in the character input button display area A changes according to the selected input mode, and the types of characters which can be inputted are also changed.

The user selects a “ [symbol] (hiragana)” button when performing an input of a hiragana character. The user selects a “ [symbol] (katakana)” button when performing an input of a katakana character. The user selects a “ [symbol] (numeral)” button when performing a input of a numeral. The user selects an “ [symbol] (alphabet)” button when performing an input of an alphabetic character. Hereinafter, an explanation will be made assuming that the “ [symbol] (hiragana)” button is selected and hence the hiragana input mode is selected.

The hit number display area E is the one in which the number of facilities each of which has a name including the character string being inputted and displayed in the input character string display area B is displayed. The facilities each of which has a name including the character string being inputted are searched for by the searching unit 14 from the database 4a according to the character string being inputted. As the results of the search made by the searching unit 14, the number of facilities which are candidates for the facilities each of which has a name including the character string being inputted is displayed In the hit number display area E.

The facility list display button F is used for displaying a list of the facilities each of which has a name including the character string being inputted and displayed in the input character string display area B. By selecting (pushing down) this facility list display button F, the user causes the input device to display the facility list in which the names of the facilities each of which has a name including the character string being inputted and which are searched for by the searching unit 14 are listed on the screen of the display device

The user can set a target facility as his or her destination by selecting the target facility from this facility list.

FIG. 4 is a view showing a relationship between each character input button and the characters assigned to this character input button in the input device in accordance with Embodiment 1. As shown in FIG. 4, when the input mode is the hiragana input one, to each of the character input buttons respectively representing the characters ( [symbol] (a), [symbol] (ka), [symbol] (sa), [symbol] (ta), [symbol] (n), [symbol] (ha), [symbol] (ma), [symbol] (ya), [symbol] (ra), [symbol] (wa)) in [symbol] (a) row in all the columns of the Japanese hiragana table, the hiragana characters in the corresponding column of the Japanese hiragana table are assigned. At this time, the plurality of characters which construct each column are brought into correspondence with index values showing the order in which the plurality of characters are displayed every time when the corresponding button is pushed down. For example, the character input button associated with [symbol] (a) column, the characters including from “ [symbol] (a)” to “ [symbol] (o)” are brought into correspondence with the index values ranging from 0 to 4, respectively, and “ [symbol] (a)” to “ [symbol] (o)” which are small hiragana characters are brought into correspondence with the index values ranging from 5 to 9, respectively.

Next, the operation of the input device will be explained.

First, an outline of the character input processing will be described.

The user can input a character string, such as a facility name, by performing an operation of touching character input buttons in the character input button display area A on the screen 5a for character input.

The display control unit 13 displays characters being inputted in the input character string display area B.

The searching unit 14 searches through the database 4a according to the character string being inputted displayed in the input character string display area B, and extracts facility names each including the character string being inputted from the database 4a. The searching unit 14 specifies candidate characters each of which can be inputted so as to follow the character string being inputted from the extracted facility names.

The searching unit 14 also notifies the number of facilities each of which has a name including the character string being inputted and which the searching unit has acquired as the search results to the display control unit 13. As a result, the display control unit 13 displays the number of facilities notified thereto from the searching unit 14 in the hit number display area E.

Next, when the user selects a character input button different from the character input button which the user has selected immediately before the selection (this case is referred to as a selection pattern 1), the operation unit 12 determines whether the character which is inputted this time exists in the candidate character group, and then notifies the determination result and the currently-inputted character to the display control unit 13.

When the currently-inputted character exists in the candidate character group, the display control unit 13 displays this inputted character in the input character string display area B as usual.

In contrast, when the currently-inputted character does not exist in the candidate character group, the display control unit 13 tones down and displays this inputted character in the input character string display area B.

In contrast, when the user selects the same button as that which the user has selected immediately before the selection (this case is referred to as a selection pattern 2), the display control unit 13 deletes the single character which the user has inputted immediately before the current selection from the input character string display area B. The searching unit 14 searches through the database 4a according to the character string in which the single character has been deleted to extract facility names each including the character string from the database 4a. The searching unit 14 specifies candidate characters each of which can be inputted so as to follow the above-mentioned character string according to the facility names which the searching unit has acquired as the search results, and updates the candidate character group.

The operation unit 12 determines whether the character which is inputted instead of the character which has been deleted (i.e. the character which is inputted this time) exists in the candidate character group updated by the searching unit 14.

When the currently-inputted character exists in the candidate character group, the display control unit 13 displays this inputted character in the input character string display area B as usual.

In contrast, when the currently-inputted character does not exist in the candidate character group, the display control unit 13 tones down and displays this inputted character in the input character string display area B.

When the process in the selection pattern 1 or the selection pattern 2 is completed, the searching unit 14 searches through the database 4a according to the character string being inputted to extract facility names each including the character string being inputted from the database 4a. The searching unit 14 specifies candidate characters each of which can be inputted so as to follow the character string being inputted from the extracted facility names.

The display control unit 13 displays the number of facilities extracted by the searching unit 14 in the hit number display area E. The input device repeatedly performs these operations until the user completes his or her character input operation.

Next, the details of the character input processing will be explained.

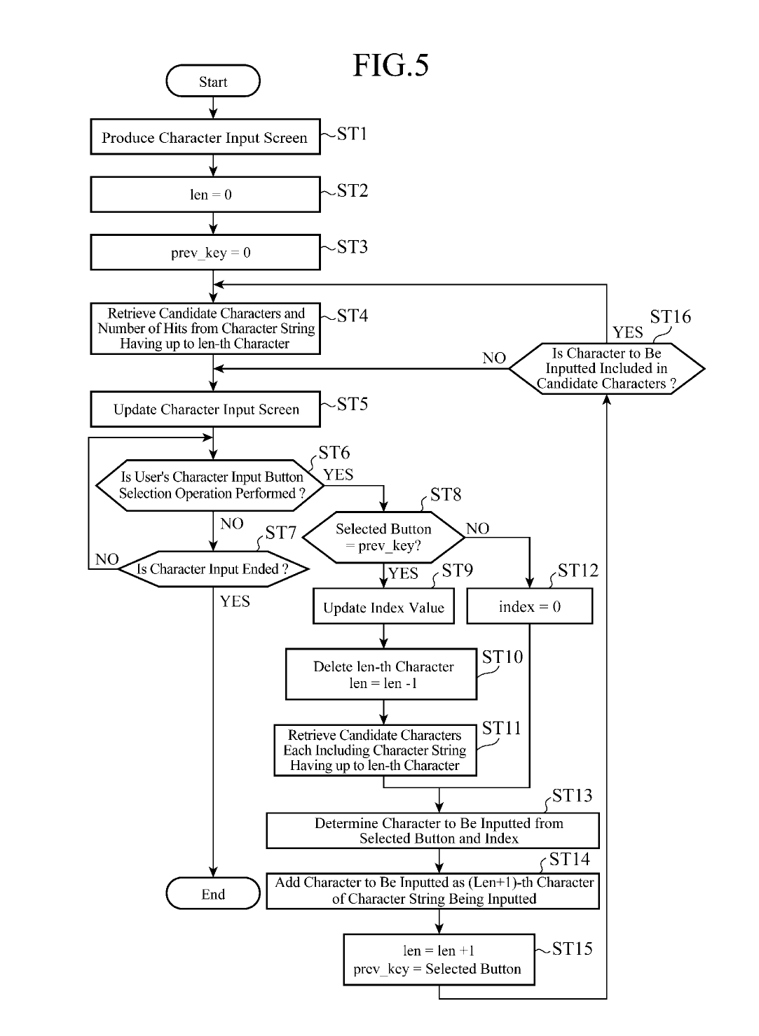

FIG. 5 is a flow chart showing a flow of the operation of the input device in accordance with Embodiment 1. A processing procedure carried out by the control circuit 2 in a display process of displaying the screen for character input 5a and in a display process at the time of a character input will be shown. The display process at the time of a character input will be explained with reference to this flow chart.

First, the display control unit 13 produces the screen for character input 5a, and displays this screen for character input on the display device 5 (step ST1). For example, by executing a program for the character input process, and a program module which implements the function of the screen for character input 5a included in the program for the character input process, the CPU of the control circuit 2 functions as the display control unit 13 to display the screen for character input 5a on the display device 5.

Hereafter, it is assumed that the hiragana mode (hiragana input) is set as the input mode in an initial state.

The operation unit 12 sets an input character string length len which is a parameter showing the length of a character string being inputted to “0” (step ST2). The operation unit 12 then sets (initializes) the contents of a storing part prev_key for storing ID information about the character input button which has been selected just previously to “0”, the ID information being included in the pieces of ID information for identification respectively added to all the character input buttons (step ST3). The storing part prev_key is constructed in the external storage unit 4 or the internal memory 9.

Next, the searching unit 14 refers to the input character string length len, and searches through the database 4a according to a character string being inputted and displayed in the input character string display area B, and extending from the first character and having a length corresponding the value of the input character string length len (referred to as a character string being inputted extending up to the len-th character from here on) to extract facility names each including this character string being inputted from the database 4a. The searching unit 14 then specifies candidate characters each of which can be inputted so as to follow to the character string being inputted from the extracted names of facilities, and also determines the number of search hits of these facilities (step ST4). At the time that the input device is started for the first time, all the characters are candidate characters, and the number of search hits is set to zero (non-display of the number of hits).

The display control unit 13 updates the screen for character input 5a by using the character candidates and the number of search hits which are determined by the searching unit 14 (step ST5). At this time, the display control unit 13 displays the inputted character (the len-th character) which has been specified to follow the character string being inputted and displayed in the input character string display area B as usual when the inputted character is included in the candidate characters.

In contrast, when the len-th character is not included in the candidate characters, the display control unit 13 tones down and displays the len-th character in the input character string display area B. At this time, in order to enable a change of the len-th character which is toned down and displayed in the input character string display area B, the display control unit 13 displays the character input button identified by the ID information stored in the storing part prev_key (the character input button to which the len-th character is assigned) as usual.

At this time, because there is no facility name including the character string displayed in the input character string display area B, the display control unit 13 displays “0” in the hit number display area E, and also tones down and displays the facility list button F and all character input buttons other than the character input button to which the above-mentioned len-th character is assigned (i.e. all character input buttons other than the character input button identified by the ID information stored in the storing part prev_key).

Further, the ID information of the character input button which is toned down and displayed is notified from the display control unit 13 to the operation unit 12. The operation unit 12 does not accept any selection operation on the character input button which is toned down and displayed by specifying the character input button according to the ID information notified thereto from the display control unit 13. The operation unit continues this selection disable mode until receiving a notification showing that the display control unit 13 has released the toning down display and then returned to a normal display (the ID information of the character input button for which the toning down display has been released).

The operation unit 12 accepts a selection of a character input button which is usually displayed, and determines whether or not a selection of a character input button using the input specifying device 8 or the remote control 11 has been made (step ST6). At this time, when there is no selection of a character input button (when NO in step ST6), the operation unit 12 determines whether or not the character input has been ended (step ST7). For example, when the user selects the facility list display button F as an operation showing an end of the character input, the operation unit 12 determines that the character input is ended (when YES in step ST7), and ends the operation concerning the character input. Further, when no operation showing an end of the character input is performed and the character input is not ended (when NO in step ST7), the operation unit returns to the process of step ST6.

When a character input button is selected by the user by using the input specifying device 8 or the remote control 11 (when YES in step ST6), the operation unit 12 determines whether the character input button selected at this time is the same as the character input button identified by the ID information stored in the storing part prev_key (the character input button which has been selected immediately before the current selection) (step ST8).

When the character input button selected at this time is the same as the character input button which has been selected immediately before the current selection (when YES in step ST8), the operation unit 12 updates the value of the parameter index (step ST9). A plurality of characters are assigned to each character input button in a predetermined order. The value of the parameter index is updated according to the number of times that an identical character input button is selected continuously, and each of the plurality of characters assigned to this character input button can be specified in increasing order of the index value.

The parameter index is updated in such a way that every time when a character input button is selected, the value which is acquired by adding “1” to the preceding index value is divided by the number of characters assigned to the character input button which is selected this time to acquire the remainder, and this remainder is set as a new parameter value.

For example, in the case in which the assignment of characters to each of the character input buttons is as shown in FIG. 4, when the character input button associated with [symbol] (a) column is selected twice, the value of the index is given by the following equation: (0+1)/10=0 with remainder=1, and the index becomes equal to 1 because the initial value of the index is “0”, and the ten characters including from the character “ [symbol] (a)” to the character “ [symbol] (o)” which is a small hiragana character are assigned to the character input button. At this time, referring to the correspondence list shown in FIG. 4, “ [symbol] (i)” is specified as the character to be inputted.

Further, in a state in which the character “ [symbol] (o)” which is a small hiragana character is selected already, i.e. index=9, when the character input button associated with [symbol] (a) column is also selected, the value of the index is given by the following equation: (9+1)/10=1 with remainder=0, and the index becomes equal to 0. At this time, referring to the correspondence list shown in FIG. 4, “ [symbol] (a)” is specified as the character to be inputted.

When the index value is updated, the display control unit 13 numbers the characters included in the character string being inputted and displayed in the input character string display area B from the head (leftmost end) of the character string being inputted one by one, and deletes the character numbered the same as the value of the input character string length len (the character which has been inputted just previously and is referred to as the len-th character) from the above-mentioned character string being inputted and displayed in the input character string display area B, and then decrements the value of the input character string length len by “1” (step ST10).

The searching unit 14 specifies the character string being inputted including up to the len-th character with reference to the value of the input character string length len which is decremented by one in step ST10, and searches through the database 4a according to the character string being inputted including up to this len-th character to extract facility names each including the character string being inputted including up to the len-th character from the database 4a, and specify candidate characters each of which can be inputted so as to follow the character string being inputted from the extracted facility names (step ST11).

In contrast, when the character input button which is selected this time differs from the character input button which has been selected immediately before the current selection (when NO in step ST8), the operation unit 12 sets the index value to “0” (step ST12). After that, the operation unit make a transition to a process of step ST13 without passing through the processes of steps ST9 to ST11.

The operation unit 12, in step ST13, determines the character which is selected as a character to be inputted through the user's operation on the basis of both the character input button which is selected this time and the value of the index.

In the case in which the character input buttons and the assignment of characters to each of the character input buttons have a correspondence as shown in FIG. 4, for example, when the character input button associated with [symbol] (ta) column is continuously selected four times, the value of the index is set to “3”. With reference to the correspondence list of FIG. 4 on the basis of these relationships, the operation unit 12 determines that the character to be inputted is “ [symbol] (te)”. The character determined at this time is notified from the operation unit 12 to the display control unit 13. The correspondence list data shown in FIG. 4 are stored in the external storage unit 4 or the internal memory 9.

The display control unit 13 additionally displays the character notified thereto from the operation unit 12 at the tail end of the character string being inputted and currently being displayed in the input character string display area B (as the character numbered (the value of the input character string length len+1)) (step ST14). The searching unit 14 then adds “1” to the value of the input character string length len, and the operation unit 12 stores the ID information of the character input button which is selected this time in the storing part prev_key (step ST15).

The operation unit 12 determines whether or not the character which the operation unit 12, in step ST13, has determined is the character to be inputted is included in the candidate characters determined by the searching unit 14 in step ST4 or ST11 (step ST16). When the character to be inputted is included in the candidate characters (when YES in step ST16), the operation unit make a transition to the process of step ST4, and the searching unit 14 retrieves candidate characters and the number of search hits again. In contrast, when the above-mentioned character to be inputted is not included in the candidate characters (when NO in step ST16), the operation unit make a transition to the process of step ST5.

When, in step ST16, determining that the character to be inputted is included in the candidate characters, the operation unit produces a normal operation sound from the speaker 6, whereas when determining that the character to be inputted is not included in the candidate characters, the operation unit produces an operation sound differing from the normal operation sound and making the user feel gloomy (or a quiet sound) from the speaker. By doing in this way, the input device can state clearly that the user has tried to input a character which is not included in the candidate characters.

As an alternative, when, in step ST16, determining that the character to be inputted is included in the candidate characters, the operation unit can cause the vibrating device 7 to vibrate with a normal vibration amount or at a normal vibration frequency, whereas when determining that the character to be inputted is not included in the candidate characters, the operation unit can cause the vibrating device to vibrate with a vibration amount different from the normal vibration amount or at a vibration frequency different from the normal vibration frequency. Also in this case, the input device can state clearly that the user has tried to input a character which is not included in the candidate characters.

Hereafter, a display example of the screen for character input 5a according to the user's character input operation will be explained.

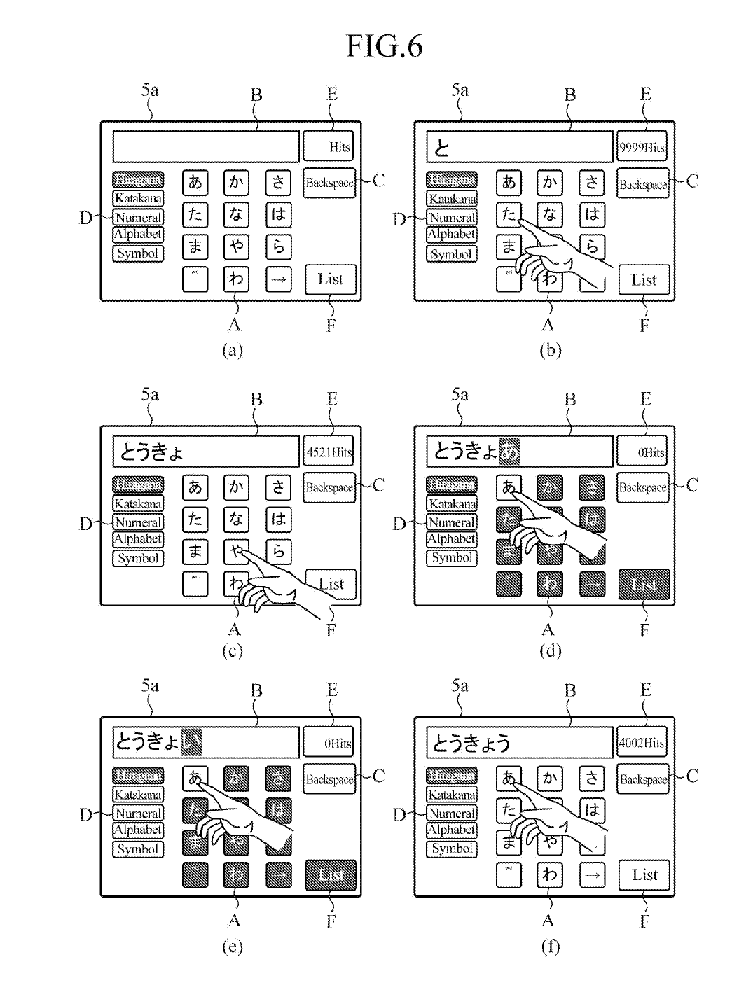

FIG. 6 is the view showing a display example of the screen for character input according to the user's character input operation. The screen for character input 5a shown in FIG. 6(a) is a one in an initial state in which the car navigation device 1 is set to a character input mode. In this example, because the car navigation device is set to the hiragana input mode, the twelve character input buttons including “ [symbol] (a)”, “ [symbol] (ka)”, “ [symbol] (sa)”, “ [symbol] (ta)”, “ [symbol] (na)”, “ [symbol] (ha)”, “ [symbol] (ma)”, “ [symbol] (ya)”, “ [symbol] (ra)”, “ [symbol] (wa)”, “ [symbol] ”, and “→” are displayed in the character input button display area A shown in FIG. 6. Further, a plurality of characters according to the correspondence shown in FIG. 4 are assigned to the character input button associated with each of “ [symbol] (a)” through “ [symbol] (wa)” columns. Because the display example shown in FIG. 6(a) is the screen produced at the above-mentioned time when the input device is started for the first time, nothing is displayed in the input character string display area B and in the hit number display area E.

The user performs a character input by performing a touch operation on the touch panel (input specifying device 8) to select a character input button to which a character which the user desires to input is assigned. When the user desires to input “ [symbol] (to)”, for example, in a state in which the screen shown in FIG. 6(a) is displayed, the user selects the character input button associated with [symbol] (ta) column five times. As a result, the character “ [symbol] (to)” is displayed at the head (left end) of the input character string display area B, as shown in FIG. 6(b). At this time, the number of facilities each having a name including “ [symbol] (to)” is displayed in the hit number display area E.

Then, when the user selects the character input button associated with [symbol] (a) column three times, then selects the character input button associated with [symbol] (ka) column twice, and further selects the character input button associated with [symbol] (ya) column six times, “ [symbol] (u)”, “ [symbol] (ki)”, and “ [symbol] (yo)” which is a small hiragana character are inputted. As a result, “ [symbol] (toukyo)” is displayed in the input character string display area B, as shown in FIG. 6(c). The number of facilities each having a name including “ [symbol] (toukyo)” is displayed in the hit number display area E.

When the user selects the character input button associated with [symbol] (a) column first in order to input “ [symbol] (u)” after “ [symbol] (toukyo)”, “ [symbol] (toukyoa)” is displayed in the input character string display area B, as shown in FIG. 6(d). At this time, when “ [symbol] (a)” is not included in the candidate characters each of which can be inputted so as to follow “ [symbol] (toukyo)”, the display control unit 13 tones down and displays “ [symbol] (a)” in the input character string display area B, and usually displays the character input button associated with [symbol] (a) column in order to enable an input of the characters other than “ [symbol] (a)”. Further, the display control unit displays zero in the hit number display area E, and tones down and displays the character input buttons other than the character input button associated with [symbol] (a) column and the facility list display button F to force the input device not to accept any input by the user using these buttons.

When the user further selects the character input button associated with (a) column in the state in which the screen shown in FIG. 6(d) is displayed, “ [symbol] (toukyoi)” is displayed in the input character string display area B, as shown in FIG. 6(e). At this time, when “ [symbol] (i)” is not included in the candidate characters each of which can be inputted so as to follow “ [symbol] (toukyo)”, the display control unit tones down and displays “ [symbol] (i)” in the input character string display area B. Further, like in the case of FIG. 6(d), the display control unit displays zero in the hit number display area E, and tones down and displays the character input buttons other than the character input button associated with [symbol] (a) column and the facility list display button F to force the input device not to accept any input by the user using these buttons.

When the user further selects the character input button associated with [symbol] (a) column in the state in which the screen shown in FIG. 6(e) is displayed, “ [symbol] (toukyou)” is displayed in the input character string display area B, as shown in FIG. 6(f). When “ [symbol] (u)” is included in the candidate characters each of which can be inputted so as to follow “ [symbol] (toukyo)”, the display control unit 13 usually displays “ [symbol] (toukyou)” in the input character string display area B.

Further, the number of hits of a facility which has a name including “ [symbol] (toukyo)” is displayed in the hit number display area E, the toning down display of the input character button display area A and the facility list display button F is released, a selection operation on the character input buttons other than the character input button associated with [symbol] (a) column is accepted, and a display of the facility list in which facilities each of which has a name including “ [symbol] [symbol] (toukyo)” are listed is enabled.

Thus, when the character to be inputted is not included in the candidate characters, the display control unit tones down and displays the character in the input character string display area B, and also displays zero in the hit number display area E. As a result, the input device can show the user visually that the character cannot be inputted.

Further, by disabling the character input buttons other than the character input button to which the character to be inputted is assigned and the facility list display button F from being selected by the user, the input device can prevent any facility name not existing in the database 4a from being searched for.

When the user completes the character input and selects the facility list display button F, the operation unit 12 determines that the character input is ended (when Yes in step ST7 of FIG. 5), the input device ends the character input processing. After that, the display control unit 13 displays a list of facilities each of which has a name including the character string being inputted, and also urges the user to perform an operation of setting up a destination. When a facility name showing a destination is inputted, the control circuit 2 makes a search for a route from the current position to the destination or carries out route guidance along the route.

As mentioned above, the input device in accordance with this Embodiment 1 displays the screen for character input 5a on the display device 5, the screen including a plurality of character input buttons to each of which a plurality of characters are assigned, and each of which specifies one of the characters assigned thereto, as a character to be inputted, according to the number of times that a selection operation is performed thereon, and an input character string display area B in which characters being inputted and specified through selection operations on each of the character input buttons are displayed in order, specifies candidate characters each of which can be inputted so as to follow the character or the character string being inputted and displayed in the input character string display area B from the character strings of words each including the character or the character string being inputted, and, when a character to be inputted which is specified to follow the character or the character string being inputted and currently being displayed in the input character string display area B is not included in the candidate characters, tones down and displays the character to be inputted immediately after the character or the character string being inputted in the input character string display area B. Thus, when a character to be inputted which is specified to follow the character or the character string being inputted and currently being displayed in the input character string display area B is not included in the candidate characters each of which can be inputted so as to follow the character or the character string being inputted and displayed in the input character string display area B, the input device enables the user to recognize visually and easily any character which the user can input using this input device by toning down and displaying the character to be inputted in the input character string display area B. Therefore, by using the structure in which the user is allowed to perform a character input by using the screen for character input 5a having the plurality of character input buttons, a plurality of characters being assigned to each of the character input buttons, the input device enables the user to make a distinction between the candidate characters and the other characters, and can provide an improvement in the ease of use of the character input operation.

Further, because the operation unit 12 in accordance with this Embodiment 1 does not accept a selection operation of selecting any character input button which is toned down and displayed, the input device can prevent the user from trying to input any character which cannot be inputted thereto.

In addition, the display control unit 13 in accordance with this Embodiment 1 displays the hit number display area E in which the number of search hits of words each including the character or the character string being inputted and currently being displayed in the input character string display area B is displayed on the screen for character input, and, when a character to be inputted which is specified to follow the character or the character string being inputted and currently being displayed in the input character string display area B is not included in the candidate characters determined by the searching unit 14, tones down and displays the character to be inputted immediately after the character or the character string being inputted and displayed in the input character string display area B, and also displays that there is no hit number in the hit number display area E. By doing in this way, the input device enables the user to recognize more clearly whether or not the character to be inputted is a character which can be inputted thereto.

The input device notifies the user visually that there are no words including the character string being inputted which is followed by the character to be inputted by, for example, describing that the number of hits of a facility which has a name including this character string being inputted is zero or toning down and displaying the facility list display button F in which the list of facilities hit through the search is displayed.

In addition, when the character to be inputted which is specified to follow the character or the character string being inputted and currently being displayed in the input character string display area B is not included in the candidate characters, the display control unit 13 in accordance with this Embodiment 1 displays the character input button to which the character to be inputted is assigned as usual, and also tones down and displays the character input buttons other than this character input button. Also by doing in this way, the input device enables the user to visually and easily recognize characters which can be inputted thereto, and can provide an improvement in the ease of use of the character input.

In addition, the input device in accordance with this Embodiment 1 includes the speaker 6 for outputting an operation sound according to an operation on the operation unit 12, and the speaker 6 outputs an operation sound differing dependently upon whether or not the character to be inputted which is specified to follow the character or the character string being inputted and displayed in the input character string display area is included in the candidate characters specified by the searching unit 14. By doing in this way, because the input device auditorily notifies the user that the character to be inputted cannot be inputted in addition to the visual notification calling attention to the fact that the character to be inputted cannot be inputted, the input device can prevent the user from trying to input a character that cannot be inputted thereto more effectively.

In addition, the input device in accordance with this Embodiment 1 includes the vibrating device 7 which vibrates according to an operation on the operation unit 12, and the vibrating device 7 vibrates with a different vibration amount or at a different vibration frequency different dependently upon whether or not the character to be inputted which is specified to follow the character or the character string being inputted and displayed in the input character string display area is included in the candidate characters specified by the searching unit 14. By doing in this way, because the input device tactilely notifies the user that the character to be inputted cannot be inputted in addition to the visual notification calling attention to the fact that the character to be inputted cannot be inputted, the input device can prevent the user from trying to input a character that cannot be inputted thereto more effectively.

### Embodiment 2

While an input device in accordance with this Embodiment 2 has the same basic structure as that in accordance with above-mentioned Embodiment 1, a display control unit 13 in accordance with this Embodiment 2 performs a display process different from that in accordance with Embodiment 1 according to a character input operation.

Therefore, the structure of the input device in accordance with Embodiment 2 will be explained with reference to FIG. 2 shown in above-mentioned Embodiment 1 by taking, as an example, a case in which the input device is applied to a car navigation device shown in FIG. 1, like in the case of above-mentioned Embodiment 1.

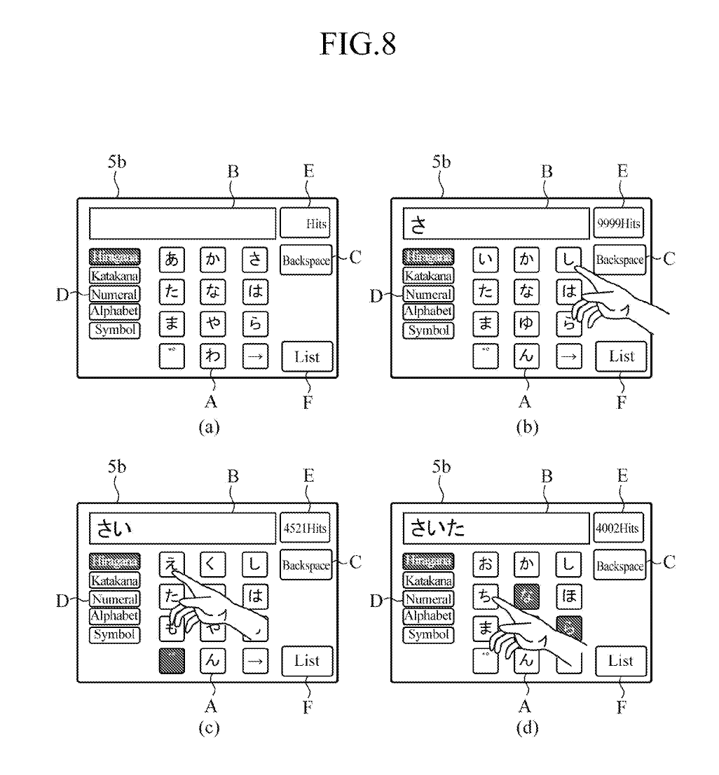

The display control unit 13 in accordance with Embodiment 2 displays a screen for character input 5b, which will be mentioned below with reference to FIG. 8, on a display device 5 when the car navigation device 1 is set to a character input mode.

In the case of a hiragana character input mode, the display control unit 13 displays a character input button group having characters ( [symbol] (a), [symbol] (ka), [symbol] (sa), [symbol] (ta), [symbol] (n), [symbol] (ha), [symbol] (ma), [symbol] (ya), [symbol] (ra), [symbol] (wa)) in [symbol] (a) column of the Japanese hiragana table in a character input button display area A of the screen for character input 5b while being in an initial state. In contrast, while being in a state in which a character has been inputted, the display control unit displays each of characters included in candidate characters each of which can be inputted so as to follow the just previously inputted character on each character input button in increasing order of an index value.

For example, when the characters included in the candidate characters each of which can be inputted so as to follow the just previously inputted character and assigned to the character input button associated with [symbol] (a) column are only “ [symbol] (i)” and “ [symbol] (e)”, the display of the character input button associated with [symbol] (a) column is changed to “ [symbol] (i)”. When this character input button is selected, not “ [symbol] (a)” but “ [symbol] (i)” is inputted, and the display of this button is changed from “ [symbol] (i)” to “ [symbol] (e)” which is the next turn. When this character input button is then selected, “ [symbol] (e)” is inputted, and the display of this button is changed from “ [symbol] (e)” to “ [symbol] (i)”, so that “ [symbol] (i)” is displayed again.

Next, the operation of the input device will be explained.

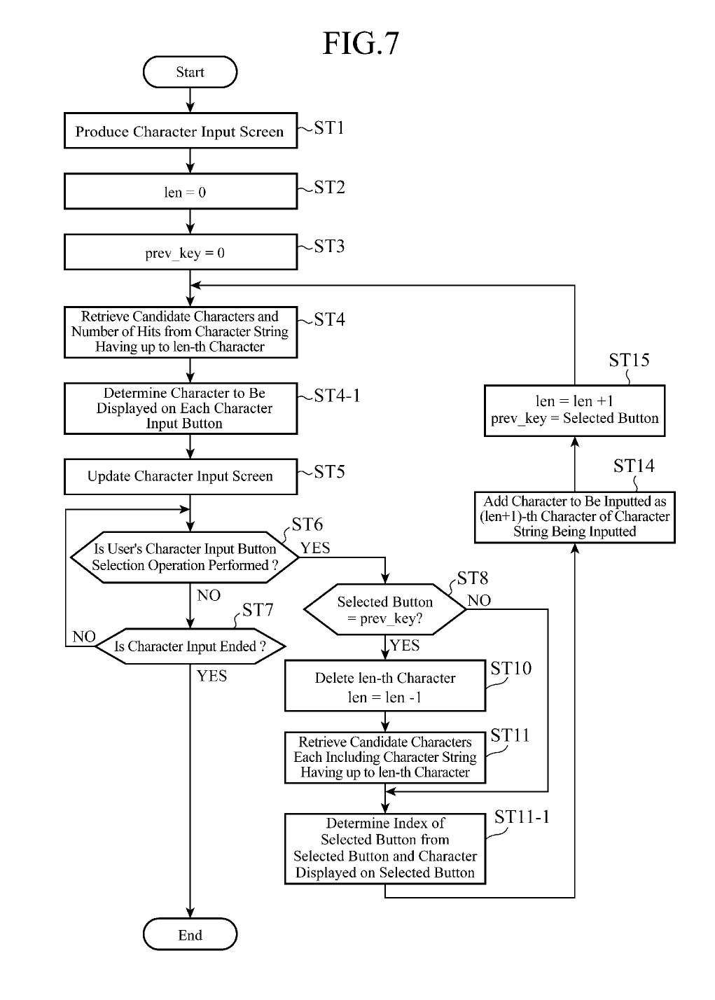

FIG. 7 is a flow chart showing a flow of the operation of the input device in accordance with Embodiment 2 of the present invention, and shows a processing procedure carried out by a control circuit 2 in a display process at the time of displaying the screen for character input 5b and at the time of performing a character input. The display process at the time of performing a character input will be explained with reference to this flow chart. Hereinafter, a case in which the input mode is a hiragana input one, and each character input button and characters assigned to this character input button have a correspondence as shown in FIG. 4 will be mentioned as an example.

First, processes of steps ST1 to ST3 are the same as those explained with reference to FIG. 5 in above-mentioned Embodiment 1.

In step ST4, a searching unit 14 refers to an input character string length len, and searches through a database 4a according to a character string being inputted including up to the len-th character and displayed in an input character string display area B to extract facility names each including this character string being inputted from the database 4a. The searching unit 14 then specifies candidate characters each of which can be inputted so as to follow the character string being inputted from the extracted facility names, and also determines the number of search hits of these facilities. When completing this process, the input device shifts to step ST4-1.

The display control unit 13 then determines a character which the display control unit will display on each character input button (step ST4-1). The character which the display control unit has determined is displayed on each character input button in step ST5. A concrete process of determining the character which the display control unit will display on each character input button is done as follows.

(1) A Character Input Button Other than the Just Previously Selected Character Input Button (prev_key)

First, an operation unit 12 determines whether or not each of the characters assigned to each of character input buttons other than the just previously selected character is included in the candidate characters in order starting from the character having an index=0 in the correspondence list shown in FIG. 4. The operation unit 12 then notifies the characters assigned to the above-mentioned character input button and included in the above-mentioned candidate characters to the display control unit 13 in increasing order of the index value.

The display control unit 13 sets the characters which are notified thereto from the operation unit 12 in the above-mentioned way as characters which are to be displayed in increasing order of the index value to each of the character input buttons other than the just previously selected character input button.

(2) The Just Previously Selected Character Input Button (prev_key)

The searching unit 14 searches through the database 4a by using the character string having up to the (len−1)-th character to specify candidate characters each of which can be inputted so as to follow the character string having up to the (len−1)-th character from the facility names each including the character string having up to the (len−1)-th character and extracted from the database 4a.

The operation unit 12 then refers to the correspondence list shown in FIG. 4 on the basis of the just previously selected character input button and the character currently being displayed on the character input button, and calculates the index value of the character currently being displayed on the character input button (after the first-time flow is done, the operation unit uses the index value acquired in step ST11-1).

Next, the operation unit 12 determines whether or not each character assigned to the just previously selected character input button is included in the candidate characters specified from the facility names each including the character string having up to the above-mentioned (len−1)-th character (after the first-time is done, the operation unit uses the candidate characters acquired in step ST11) in increasing order of the index value starting from that of the character currently being displayed on the just previously selected character input button. The operation unit 12 notifies each character, among the characters assigned to the above-mentioned character input button, which is included in the above-mentioned candidate characters to the display control unit 13 in increasing order of the index value.

The display control unit 13 sets the character notified thereto from the operation unit 12, as a character which is to be displayed in increasing order of the index value, to the just previously selected character input button according to this selection.

When no character assigned to each of the character input buttons other than the just previously selected character input button matches one of the candidate characters, the display control unit 13 sets a character associated with index=0 as the character which is to be displayed on each of the character input buttons other than the just previously selected character input button, and also sets this character input button to non-display (or tones down and displays this character input button).

Processes of steps ST6 to ST7 are the same as those explained in above-mentioned Embodiment 1 with reference to FIG. 5.

When the user selects a character input button by using an input specifying device 8 or a remote control 11, the operation unit 12, in step ST8, determines whether or not the character input button selected at this time is the same as the character input button identified by ID information stored in a storing part prev_key (the just previously selected character input button).

When the character input button selected at this time is the same as the just previously selected character input button (when YES in step ST8), the operation unit advances to a process of step ST10, whereas when the character input button selected at this time differs from the just previously selected character input button (when NO in step ST8), the operation unit advances to a process of step ST11-1.

The searching unit 14, in step ST10, counts the character string being inputted currently being displayed in the input character string display area B one by one from the head (left end) of the character string and determines a character string by deleting the character numbered the same as the value of the input character string length len (this character is referred to as the len-th character) from the above-mentioned character string being inputted, and then decrements the value of the input character string length len by “one”. When the user inputs a character for the first time, the character string is null.

The searching unit 14 then refers to the input character string length len, and specifies the character string being inputted and currently being displayed in the input character string display area B and having up to the len-th character, and searches through the database 4a according to the character string being inputted having up to this len-th character to specify candidate characters each of which can be inputted so as to follow the character string being inputted and currently being displayed in the input character string display area B from the facility names each including the character string being inputted having up to the len-th character which are extracted from the database 4a (step ST11).

The operation unit 12, in step ST11-1, refers to the correspondence list shown in FIG. 4 on the basis of the just previously selected character input button and the character currently being displayed on this character input button to determine the index value of the character currently being displayed on the character input button. The operation unit 12 notifies the character currently being displayed on the just previously selected character input button and the index value of the character to the display control unit 13.

The display control unit 13 additionally displays the character notified thereto from the operation unit 12 (the character currently being displayed on the just previously selected character input button) at the tail end of the character string being inputted and currently being displayed in the input character string display area B (as a character numbered (input character string length len+1) from the first one) (step ST14). Next, the searching unit 14 adds “1” to the value of the input character string length len, and the operation unit 12 sets the ID information of the just previously selected character input button to the storing part prev_key (step ST15).

After that, the searching unit 14 returns to the process of step ST4, refers to the input character string length len, and searches through the database 4a according to the character string being inputted having up to the len-th character, which is currently being displayed in the input character string display area B, to extract the facility names each including this character string being inputted from the database 4a. The searching unit 14 specifies candidate characters each of which can be inputted follow to the character string being inputted from the extracted facility names, and also determines the number of search hits of these facilities. After that, the searching unit repeats the above-mentioned processing until the character input is ended.

Hereafter, a display example of the screen for character input 5b according to the user's character input operation will be explained.

FIG. 8 is a view showing a display example of the screen for character input according to a character input operation. The screen for character input 5b of FIG. 8(a) shows a screen in an initial state in which the car navigation device 1 is set to a character input mode. In this example, because the car navigation device is set to a hiragana character input mode (hiragana input), 12 character input buttons including an “ [symbol] (a)” button, a “ [symbol] (ka)” button, a “ [symbol] (sa)” button, a “ [symbol] (ta)” button, an “ [symbol] (na)” button, a “ [symbol] (ha)” button, a “ [symbol] (ma)” button, a “ [symbol] (ya)” button, a “ [symbol] (ra)” button, a “ [symbol] (wa)” button, a “ [symbol] ” button, and a “→” button are displayed in the character input button display area A shown in FIG. 8. A plurality of characters are assigned to the character input button associated with each of “ [symbol] (a)” to “ [symbol] (wa)” columns according to the correspondence shown in FIG. 4. Because FIG. 8(a) shows a screen corresponding to a one at the time when the input device is started for the first time, nothing is displayed in the input character string display area B and in a hit number display area E. The user performs a character input by performing a touch operation on a touch panel (input specifying device 8) to select a character input button to which a character which the user desires to input is assigned.

A case in which the user desires to input, for example, “ [symbol] (saitama)” in a state in which the screen shown in FIG. 8(a) is displayed will be explained below. First, the user selects the “ [symbol] (sa)” character input button on the screen for character input 5b shown in FIG. 8(a). As a result, the character “ [symbol] (sa)” is displayed at the head (left end) of the input character string display area B, as shown in FIG. 8(b). At this time, on each of the character input buttons other than the “ [symbol] (sa)” character input button in the character input button display area A, a character which is included in the candidate characters each of which can be inputted so as to follow “ [symbol] (sa)” and having the smallest index value, among the characters assigned to the character input button, is displayed.

For example, in the case of the character input button associated with [symbol] (a) column, when the candidate characters each of which can be inputted so as to follow “ [symbol] (sa)” are “ [symbol] (i)”, “ [symbol] (e)” and “ [symbol] (o)”, “ [symbol] (i)” (index=1) having the smallest index value is displayed on the character input button according to the correspondence list shown in FIG. 4.

In contrast, in the case of the character input button associated with [symbol] (sa) column which is selected this time (which is just previously selected), the input device needs to allow a selection of either one of “ [symbol] (si)”, “ [symbol] (su)”, “ [symbol] (se)”, and “ [symbol] (so)”, as well as “ [symbol] (sa)”. Therefore, on the character input button associated with [symbol] (sa) column, not one of the candidate characters which can be inputted so as to follow the character “ [symbol] (sa)”, but a character included in the candidate characters which can be inputted so as to follow the character string in which the last character of the character string being inputted and currently being displayed in the input character string display area B is deleted, i.e. the (len−1)-th character of the character string being inputted, and having the smallest index value is displayed on the character input button.

Because when only the single character “ [symbol] (sa)” is inputted first, a null character string is acquired by subtracting one from the input character string length len, “ [symbol] (si)” having the smallest one of the index values of the characters succeeding “ [symbol] (sa)” is set as a character displayed instead of “ [symbol] (sa)”, as shown in FIG. 8(b).

When the user then selects the character input button associated with [symbol] (a) column in which the character “ [symbol] (i)” is displayed in the state in which the screen of FIG. 8(b) is displayed, the character “ [symbol] (i)” is inputted just as it is, and “ [symbol] (sai)” is displayed in the input character string display area B, as shown in FIG. 8(c).

At this time, on each character input button other than the character input button associated with [symbol] (a) column which is selected this time, the character included in the candidate characters each of which can be inputted so as to follow “ [symbol] (sai)” and having the smallest index value is displayed. For example, when the following five characters: “ [symbol] (ta)”, “ [symbol] (ti)”, “ [symbol] (tu)”, “ [symbol] (te)”, and “ [symbol] (to)” are specified for the character input button associated with [symbol] (ta) column as the candidate characters each of which can be inputted so as to follow the character string being inputted “ [symbol] (sai)”, “ [symbol] (ta)” having the smallest index value is displayed on the button associated with [symbol] (ta) column, as shown in FIG. 8(c).

In contrast, in the case of the character input button associated with [symbol] (a) column which is selected this time, the input device needs to allow a selection of either one of the candidate characters “ [symbol] (e)” and “ [symbol] (o)” each of which can be inputted so as to follow the character “ [symbol] (sa)” which has been inputted until the last time, instead of the character “ [symbol] (i)” which is inputted this time. Therefore, on the character input button associated with [symbol] (a) column which is selected this time, not one of the candidate characters which can be inputted to follow the character string being inputted “ [symbol] (sai)”, but the character “ [symbol] (e)” included in the candidate characters which can be inputted so as to follow the (len−1)-th character of the character string being inputted and having the smallest index value is displayed (refer to FIG. 8(c)).

When the user then selects the character input button associated with [symbol] (ta) column, in which the character “ [symbol] (ta)” is displayed, in the state in which the screen of FIG. 8(c) is displayed, the character “ [symbol] (ta)” is inputted juts as it is, and “ [symbol] (saita)” is displayed in the input character string display area B, as shown in FIG. 8(d).

At this time, on each character input button other than the character input button associated with [symbol] (ta) column, the character included in the candidate characters each of which can be inputted so as to follow “ [symbol] (saita)” and having the smallest index value is displayed. For example, in the case of the character input button associated with [symbol] (ma) column, when the following two characters: “ [symbol] (ma)” and “ [symbol] (mo)” are specified as the candidate characters each of which can be inputted so as to follow the character string being inputted “ [symbol] (saita)”, “ [symbol] (ma)” having the smallest index value is displayed on the button associated with [symbol] ma) column, as shown in FIG. 8(d).

In contrast, in the case of the character input button associated with [symbol] (ta) column which is selected this time, the input device needs to allow a selection of either one of the candidate characters “ [symbol] (ti)”, “ [symbol] (tu)”, “ [symbol] (te)” and “ [symbol] (to)” each of which can be inputted so as to follow the character “ [symbol] (sai)” which has been inputted until the last time, instead of the character “ [symbol] (ta)” which is inputted this time.

Therefore, on the character input button associated with [symbol] (ta) column which is selected this time, the character “ [symbol] (ti)” included in the candidate characters each of which can be inputted so as to follow the (len−1)-th character “ [symbol] (i)” of the character string being inputted and having the smallest index value is displayed.

Finally, by selecting the character input button associated with [symbol] (ma) column on which the character “ [symbol] (ma)” is displayed in the state in which the screen of FIG. 8(d) is displayed, the user can input “ [symbol] (saitama)” to the input device.

When a character input button has no character assigned thereto and included in the candidate characters, this character input button is toned down and displayed (refer to FIG. 8(c) or 8(d)).

The ID information of the character input button which is toned down and displayed is notified from the display control unit 13 to the operation unit 12. The operation unit 12 does not accept any selection operation of selecting the character input button which is toned down and displayed by specifying the character input button according to the ID information notified thereto from the display control unit 13. The operation unit continues this selection disable mode until receiving a notification showing that the display control unit 13 has released the toning down display and returned to a normal display (the ID information of the character input button for which the toning down display has been released) from the display control unit 13.

Further, when the number of search hits of facility names is zero, the display control unit 13 displays zero in the hit number display area E, and tones down and displays a facility list display button F. By disabling any button which is toned down and displayed to be selected, the input device can notify the user visually that the user cannot select the facility list display button F.

As mentioned above, in accordance with this Embodiment 2, the display control unit 13 displays only a character, among the plurality of characters assigned to each character input button, which is included in the candidate characters specified by the searching unit 14 on the character input button. In this structure, the display control unit 13 displays one or more characters, among the plurality of characters assigned to each character input button, which are included in the candidate characters specified by the searching unit 14 on the character input button in increasing order of the number of times that a selection operation is needed for the specification (i.e. in increasing order of the index value). By doing in this way, the input device can prevent the user from trying to input a character that cannot be inputted thereto more effectively.

Further, because the display control unit displays the one or more characters on the character input button in increasing order of the index value (i.e. in increasing order of the number of times that a selection operation is needed), the input device makes it easy for the user to visually judge which character the user can input by making a selection of a character input button, thereby being able to improve the ease of use of the character input.

Although in above-mentioned Embodiments 1 and 2, the case in which the input device in accordance with the present invention is applied to an input of a facility name in the car navigation device 1 is described, the database which is the search target can be a music database or a telephone directory.

More specifically, although in above-mentioned Embodiments 1 and 2, the input device specifies candidate characters to be displayed on each character input button from facility names each including the character string being inputted, the input device can alternatively search through the database 4a in which words to be inputted are registered to extract words each including the character string being inputted, and specify candidate characters from the character strings of these words extracted thereby.

For example, in the case of a music database, the input device can extract the names of musical pieces each including the character string being inputted from the music database to specify candidate characters. Further, in the case of a telephone directory, the input device can extract addresses or telephone numbers each including the character string being inputted from the telephone directory to specify candidate characters.

In addition, in above-mentioned Embodiments 1 and 2, when a character to be inputted which is specified to follow the character or the character string being inputted and currently being displayed in the input character string display area B is included in the candidate characters specified by the searching unit 14, the display control unit 13 switches between the process of toning down and displaying the character to be inputted immediately after the character or the character string being inputted in the input character string display area B (i.e. the display process in accordance with Embodiment 1), and the process of displaying only a character, among the plurality of characters assigned to each character input button, which is included in the candidate characters specified by the searching unit 14 on the character input button (i.e. the display process in accordance with Embodiment 2) according to the time required for the user to perform a selection operation of selecting a character input button, which is detected by the operation unit 12 (the time required for the user to push down the character input button).

For example, when the time required for the user to perform a selection operation of selecting a character input button once exceeds a predetermined time, the display control unit can accept specification of only a character, among the plurality of characters assigned to the character input button, which is included in the candidate characters specified by the searching unit 14, like that in accordance with above-mentioned Embodiment 2, whereas when the time required for the user to perform a selection operation of selecting a character input button once is equal to or shorter than the predetermined time, the display control unit can accept specification of any one of all the characters assigned to the character input button, like that in accordance with above-mentioned Embodiment 1.

By thus switching between the input process in accordance with above-mentioned Embodiment 1 and that in accordance with above-mentioned Embodiment 2 through the simple selection operation, the input device can provide both of the advantages provided by above-mentioned Embodiments 1 and 2.

### Embodiment 3

In this Embodiment 3, a case in which the concept underlying the character input explained in the above-mentioned Embodiment 1 is applied to an input of English. While an input device in accordance with Embodiment 3 has the same basic structure as that in accordance with above-mentioned Embodiment 1, the input device in accordance with Embodiment 3 differs from that in accordance with above-mentioned Embodiment 1 in that the input device performs an input of English.

Therefore, the structure of the input device in accordance with Embodiment 3 will be explained with reference to FIG. 2 shown in above-mentioned Embodiment 1 by taking a case in which the input device is applied to a car navigation device shown in FIG. 1 as an example, like in the case of above-mentioned Embodiment 1.

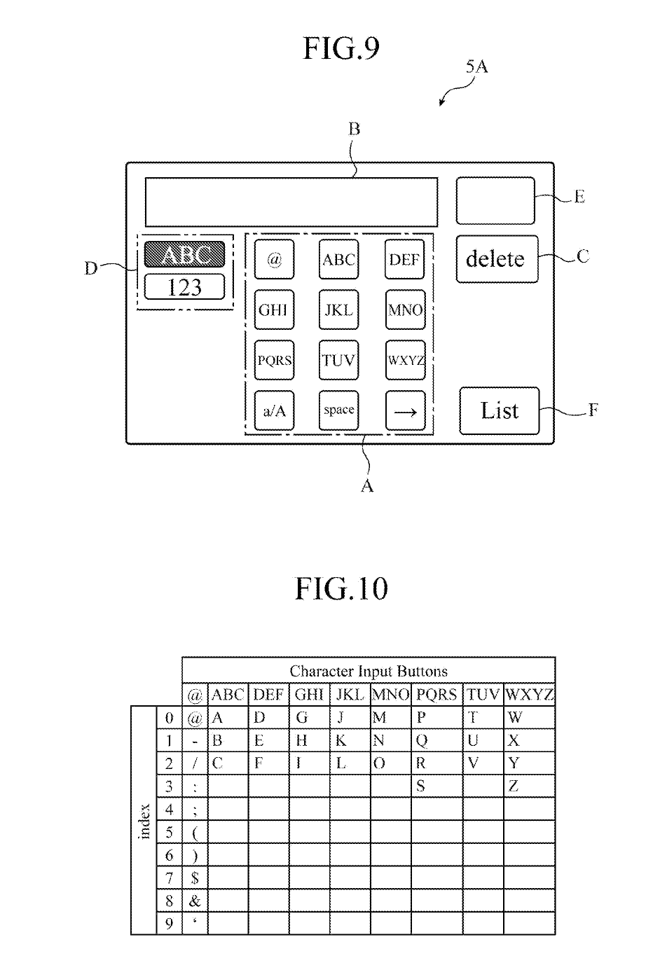

FIG. 9 is a view showing an example of a screen for character input in accordance with Embodiment 3. A character input button display area A, an input character string display area B, a delete button C, an input mode switching button D, a hit number display area E, and a facility list display button F are disposed on the screen for character input 5A of FIG. 9.

Buttons each for allowing the user to select a character to be inputted (referred to as character input buttons from here on) are displayed in the character input button display area A.

When the input mode is an alphabet input mode (when an “ABC” button is selected), a character input button group as shown in FIG. 9 is displayed.

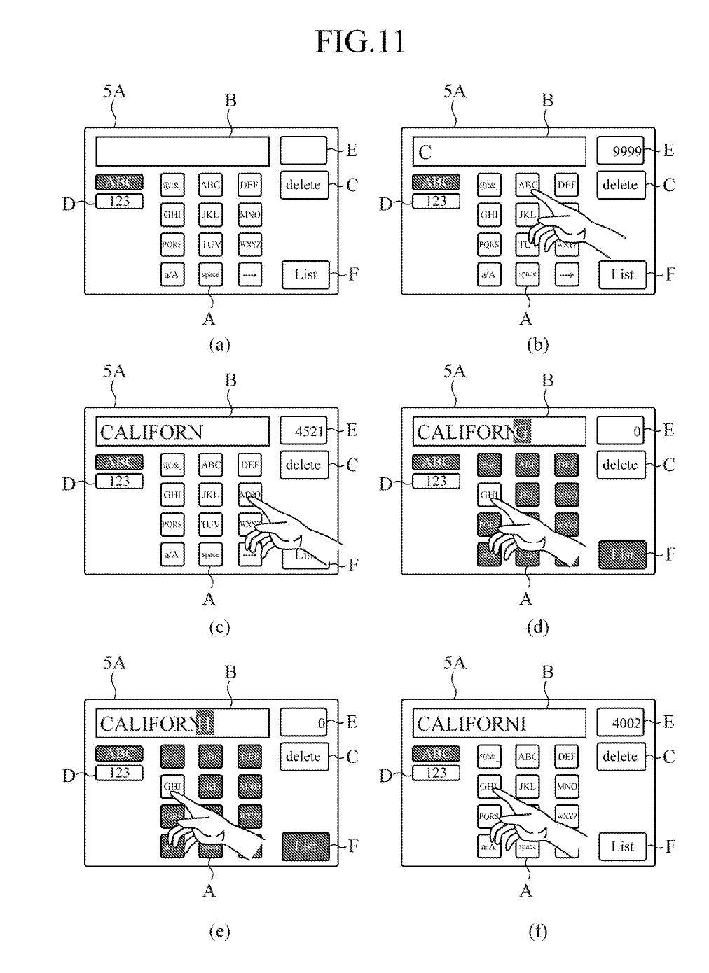

A plurality of characters are assigned to each character input button, as will be mentioned below with reference to FIG. 10, and every time when the user selects (pushes down) each character input button, the character to be inputted changes in the following way: “A→B→C→A . . . ” in turn. For example, when trying to input “SAN”, the user can this word by selecting a “PQRS” character input button four times, selecting an “ABC” character input button once, and then selecting a “MNO” character input button twice.

Further, an “a/A” button is used when the user causes the input device to convert the just previously inputted character into the uppercase version or the lowercase version. A “→i” button is used when the user determines an input of the first character in order to continuously input characters assigned to the same button. For example, when inputting “GI”, the user can input this word by selecting the “→” button after selecting a “GHI” character input button, and then selecting the “GHI” character input button three times. A space button is used when the user inputs a space.

In the example of the correspondence shown in FIG. 9, although the “a/A” button is disposed to enable the user to cause the input device to convert the just previously inputted character into the uppercase version or the lowercase version, an input of the uppercase version or the lowercase version of a character can be done in the following way.

For example, the following characters: A, B, C, a, b, and c are assigned to the “ABC” button while the characters are brought into correspondence with index values increasing in the order of the characters, respectively. When inputting an uppercase character “A”, the user selects the “ABC” character input button once. When inputting a lowercase character “a”, the user selects the “ABC” character input button four times.

The input character string display area B is the one in which the user causes the input device to display a character inputted thereby by performing an operation using an input specifying device 8 or a remote control 11. Input characters which the user has selected are displayed in this input character string display area B one by one.

The delete button C is used for deleting a character displayed in the input character string display area B. By pushing down this delete button C, the user can delete the character at the tail end of the character string currently being displayed in the input character string display area B.

The input mode switching button D is used for enabling the user to select the type of a character to be inputted. When one of various input modes is selected, the character representation of the character input buttons displayed in the character input button display area A changes according to the selected input mode, and the types of characters which can be inputted are also changed.

The user selects the “ABC” button when performing an input of an alphabetic character or a symbol. The user selects a “123” button when performing an input of a numeral. Hereafter, an explanation will be made assuming that the “ABC” button is selected.

The hit number display area E is the one in which the number of facilities each of which has a name including the character string being inputted and displayed in the input character string display area B is displayed. The facilities each of which has a name including the character string being inputted are searched for by a searching unit 14 from a database 4a according to the character string being inputted. As the result of the search made by the searching unit 14, the number of facilities which are candidates for the facilities each of which has a name including the character string being inputted is displayed in the hit number display area E.

The facility list display button F is used for displaying a list of the facilities each of which has a name including the character string being inputted and displayed in the input character string display area B. By selecting (pushing down) this facility list display button F, the user causes the input device to display the facility list in which the names of the facilities each of which has a name including the character string being inputted and which are searched for by the searching unit 14 are listed on the screen of a display device 5.

The user can set a target facility as his or her destination by selecting the target facility from this facility list.

FIG. 10 is a view showing a relationship between the character input buttons and the characters assigned to each of these character input buttons in the input device in accordance with Embodiment 3. As shown in FIG. 10, when the input mode is the alphabet input one, symbols or alphabetic characters are assigned to each of the character input buttons on which “@”, “ABC”, “DEF”, “GHI”, “JKL”, “MNO”, “PQRS”, “TUV”, and “WXYZ” are displayed, respectively. At this time, the plurality of characters assigned to each character input button are brought into correspondence with index values showing the order in which the plurality of characters are displayed on the character input button. For example, in the case of the “@” character input button, symbol characters including from “@” to “′” correspond to indexes ranging from 0 to 9, respectively. In the case of the “ABC” character input button, alphabetic characters including from “A” to “C” correspond to indexes ranging from 0 to 2, respectively.

Next, the operation of the input device will be explained.

Because the input device in accordance with Embodiment 3 performs an input of English according to the same concept as that underling the character input process in accordance with above-mentioned Embodiment 1, the details of an English input process will be explained with reference to a flowchart of FIG. 5.

First, a display control unit 13 produces a screen for character input 5A and then displays this screen on the display device 5 (step ST1). For example, a CPU of a control circuit 2 functions as the display control unit 13 by executing a program for the character input process, and a program module which implements the function of the screen for character input 5A included in the program for the character input process, and displays the screen for character input 5A on the display device 5.

Hereafter, it is assumed that an “ABC” mode (symbol and alphabet input mode) is set as the input mode in an initial state.

Processes in steps ST2 to ST8 are the same as those explained in above-mentioned Embodiment 1, with the exception that the input device displays the screen for character input 5A.

When the character input button which is selected this time is the same as the character input button which has been selected immediately before the current selection (when YES in step ST8), an operation unit 12 updates the value of the parameter index (step ST9). As shown in FIG. 10, a plurality of characters are assigned to each character input button in a predetermined order, and, by updating the value of the parameter index according to the number of times that an identical character input button is selected continuously, the operation unit can specify each of the plurality of characters assigned to this character input button in increasing order of the index value.

The parameter index is updated in such a way that every time when a character input button is selected, the value which is acquired by adding “1” to the preceding index value is divided by the number of characters assigned to the character input button which is selected this time to acquire the remainder, and this remainder is set as a new parameter value.

For example, in the case in which the assignment of characters to the character input buttons is as shown in FIG. 10, when the “PQRS” character input button is selected twice, the value of the index is given by the following equation: (0+1)/4=0 with remainder=1, and the index becomes equal to 1 because the initial value of the index is “0”, and the four characters including from the character “P” to the character “S” are assigned to the character input button. At this time, referring to the correspondence list shown in FIG. 10, “Q” is specified as the character to be inputted.

Further, in a state in which the character “S” is selected already, i.e. index=3, when the “PQRS” character input button is selected, the value of the index is given by the following equation: (3+1)/4=1 with remainder=0, and the index becomes equal to 0. At this time, referring to the correspondence list shown in FIG. 10, “P” is specified as the character to be inputted.

Further, processes in steps ST10 to ST16 are also the same as those explained in above-mentioned Embodiment 1, with the exception that the input device displays the screen for character input 5A.

The operation unit 12 determines the character which is selected through the user's operation as a character to be inputted according to the character input button which is selected this time and the value of the index (step ST13).

In the case in which the assignment of characters to the character input buttons is as shown in FIG. 10, when the “PQRS” character input button is continuously selected four times, for example, the value of the index becomes equal to “3”. With reference to the correspondence list of FIG. 10 on the basis of these relationships, the operation unit 12 determines that the character to be inputted is “S”. The character determined at this time is notified from the operation unit 12 to the display control unit 13. The correspondence list data shown in FIG. 10 are stored in an external storage unit 4 or an internal memory 9.

When, in step ST16, determining that the character to be inputted is included in candidate characters, the operation unit produces a normal operation sound from a speaker 6, whereas when determining that the character to be inputted is not included in the candidate characters, the operation unit produces an operation sound differing from the normal operation sound and making the user feel gloomy (or a quiet sound) from the speaker. By doing in this way, the input device can state clearly that the user has tried to input a character which is not included in the candidate characters.

As an alternative, when, in step ST16, determining that the character to be inputted is included in the candidate characters, the operation unit can cause a vibrating device 7 to vibrate with a normal vibration amount or at a normal vibration frequency, whereas when determining that the character to be inputted is not included in the candidate characters, the operation unit can cause the vibrating device to vibrate with a vibration amount different from the normal vibration amount or at a vibration frequency different from the normal vibration frequency. Also in this case, the input device can state clearly that the user has tried to input a character which is not included in the candidate characters.

Hereafter, a display example of the screen for character input 5A according to the user's character input operation will be explained.

FIG. 11 is a view showing a display example of the screen for character input according to the user's character input operation on the input device in accordance with Embodiment 3. The screen for character input 5A shown in FIG. 11(a) is a one in an initial state in which the car navigation device 1 is set to a character input mode. In this example, because the car navigation device is set to the ABC mode (symbol and alphabet input mode), the twelve character input buttons including “@”, “ABC”, “DEF”, “GHI”, “JKL”, “MNO”, “PQRS”, “TUV”, “WXYZ”, “a/A”, “space”, and “→” are displayed in the character input button display area A shown in FIG. 11. Further, a plurality of characters are assigned to each of the character input buttons including “@” to “WXYZ” according to a correspondence as shown in FIG. 10. Because the display example shown in FIG. 11(a) is the screen displayed at the above-mentioned time when the input device is started for the first time, nothing is displayed in the input character string display area B and in the hit number display area E.

The user performs a character input by performing a touch operation on a touch panel (input specifying device 8) to select a character input button to which a character which the user desires to input is assigned. Hereafter, a case in which the user inputs the following character string: “CALIFORNIA” will be explained.

When the user desires to input “C” in the state in which the screen shown in FIG. 11(a) is displayed, for example, the user selects the “ABC” character input button three times. As a result, the character “C” is displayed at the head (left end) of the input character string display area B, as shown in FIG. 11(b). At this time, the number of facilities each having a name including “C” is displayed in the hit number display area E.

By then selecting the button once and selecting the “ABC” character input button once, and, after that, selecting each of the “JKL”, “GHI”, “DEF”, “MNO”, and “PQRS” character input buttons three times in this order, and further selecting the “MNO” character input button twice, the user inputs “A”, “L”, “I”, “F”, “O”, “R”, and “N” to the input device. Accordingly, “CALIFORN” is displayed in the input character string display area B, as shown in FIG. 11(c). The number of facility names each including “CALIFORN” is displayed in the hit number display area E.

When the user then selects the “GHI” character input button in order to input “I” immediately after “CALIFORN”, the input device displays “CALIFORNG” in the input character string display area B, as shown in FIG. 11(d). At this time, when “G” is not included in the candidate characters each of which can be inputted so as to follow “CALIFORN”, the display control unit 13 tones down and displays “G” in the input character string display area B while displaying the character input button of “GHI” as usual in order to enable the user to input characters other than “G”. The display control unit also displays zero in the hit number display area E, and tones down and displays the character input buttons other than the “GHI” character input button, and the facility list display button F, thereby preventing the input device from accepting the user's input operation on these buttons.

When the user further selects the “GHI” character input button in the state in which the screen shown in FIG. 11(d) is displayed, the input device displays “CALIFORNH” in the input character string display area B, as shown in FIG. 11(e). At this time, when “H” is not included in the candidate characters each of which can be inputted so as to follow “CALIFORN”, the input device tones down and displays “H” in the input character string display area B. The display control unit also displays zero in the hit number display area E, and tones down and displays the character input buttons other than the “GHI” character input button, and the facility list display button F, thereby preventing the input device from accepting the user's input operation on these buttons, like in the case of FIG. 11(d).

When the user further selects the “GHI” character input button in the state in which the screen shown in FIG. 11(e) is displayed, the input device displays “CALIFORNI” in the input character string display area B, as shown in FIG. 11(f). When “I” is included in the candidate characters each of which can be inputted so as to follow “CALIFORN”, the display control unit 13 normally displays “CALIFORNI” in the input character string display area B.

Further, the display control unit displays the number of hits of a facility which has a name including “CALIFORNI” in the hit number display area E, releases the toning down display of the input character button display area A and the facility list display button F, accepts a selection operation of selecting any of the character input buttons other than the “GHI” character input button, and enables a display of a facility list in which the facilities each of which has a name including “CALIFORNI” are listed. Although no subsequent process is shown in the figure, the user can input “CALIFORNIA” by selecting the “ABC” character input button once in this screen state.

When the character to be inputted is not included in the candidate characters, the display control unit tones down and displays the character in the input character string display area B, and further displays zero in the hit number display area E. As a result, the input device can show the user visually that the character cannot be inputted.

Further, by disabling the character input buttons other than the character input button to which the character to be inputted is assigned and the facility list display button F from being selected by the user, the input device can prevent any facility name not existing in the database 4a from being searched for.

When the user completes the character input and selects the facility list display button F, the operation unit 12 determines that the character input is ended (when Yes in step ST7 of FIG. 5), the input device ends the character input processing. After that, the display control unit 13 displays a list of facilities each of which has a name including the character string being inputted, and also urges the user to perform an operation of setting up a destination. When a facility name showing a destination is inputted, the control circuit 2 makes a search for a route from the current position to the destination or carries out route guidance along the route.

As mentioned above, the input device in accordance with this Embodiment 3 displays the screen for character input 5A on the display device 5, the screen including a plurality of character input buttons to each of which a plurality of characters including symbols and alphabetic characters are assigned, and each of which specifies one of the characters assigned thereto, as a character to be inputted, according to the number of times that a selection operation is performed thereon, and the input character string display area B in which characters being inputted and specified through selection operations on each of the character input buttons are displayed in order, specifies candidate characters each of which can be inputted so as to follow the character or the character string being inputted and displayed in the input character string display area B from the character strings of words each including the character or the character string being inputted, and, when a character to be inputted which is specified in such a way as to follow the character or the character string being inputted and currently being displayed in the input character string display area B is not included in the candidate characters, tones down and displays the character to be inputted immediately after the character or the character string being inputted in the input character string display area B. By doing in this way, the input device can provide the same advantages as those provided by the input device in accordance with above-mentioned Embodiment 1 even in the case of an input of English.

### Embodiment 4

In this Embodiment 4, a case in which the concept underlying the character input explained in the above-mentioned Embodiment 2 is applied to an input of English. While an input device in accordance with Embodiment 4 has the same basic structure as that in accordance with above-mentioned Embodiment 1, the input device in accordance with Embodiment 4 differs from that in accordance with above-mentioned Embodiment 1 in that the input device performs an input of English.

Therefore, the structure of the input device in accordance with Embodiment 4 will be explained with reference to FIG. 2 shown in above-mentioned Embodiment 1 by taking a case in which the input device is applied to a car navigation device shown in FIG. 1 as an example, like in the case of above-mentioned Embodiment 1.

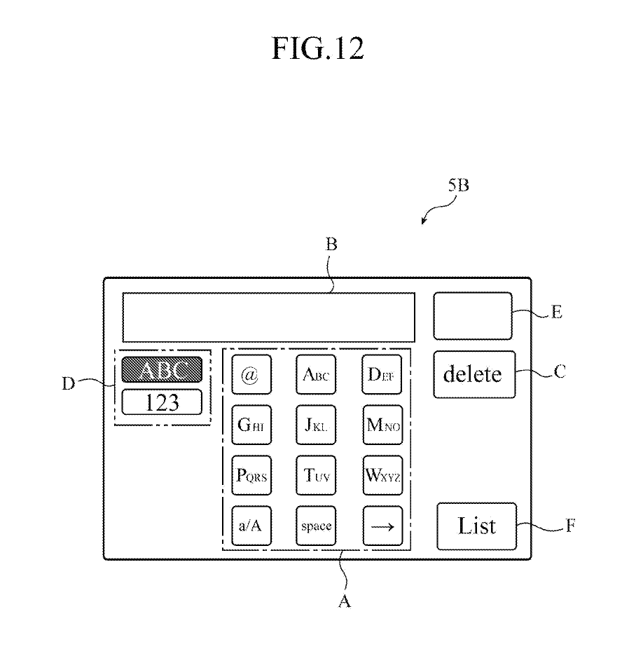

FIG. 12 is a view showing an example of a screen for character input in accordance with Embodiment 4. A display control unit 13 in accordance with Embodiment 4 displays the screen for character input 5B as shown in FIG. 12 on a display device 5 when the car navigation device 1 is set to a character input mode.

In the case of an ABC mode, the display control unit 13 displays a character input button group in which characters (@, A, D, G, J, M, P, T, and W) each having the smallest index value and included in the characters assigned to a corresponding character input button are highlighted compared with the other characters in a character input button display area A of the screen for character input 5B while being in an initial state. Although the display control unit displays the characters each having the smallest index value in a larger size than the other characters in the example of FIG. 12, the display control unit can alternatively highlight the characters each having the smallest index value by displaying these characters in bold type or in a different color.

In a state in which a character input has been performed on the screen for character input 5B, the display control unit highlights each of characters of each character input button which are included in candidate characters each of which can be inputted so as to follow the just previously inputted character in the order that the characters are assigned to the character input button.

For example, when the characters included in the candidate characters each of which can be inputted so as to follow the just previously inputted character and assigned to the “ABC” character input button are only “B” and “C”, the display of the “ABC” character input button is changed to a highlight display of “B”. When this character input button is selected, not “A” but “B” is inputted, and the highlighted character is changed to “C” having the next index value. When this character input button is then selected, “C” is inputted, and the highlighted character on this button is changed from “C” to “B”, so that “B” is highlighted again.

Next, the operation of the input device will be explained.

Because the input device in accordance with Embodiment 4 performs an input of English according to the same concept as that underling the character input process in accordance with above-mentioned Embodiment 2, the details of an English input process will be explained with reference to a flowchart of FIG. 7.

First, processes of steps ST1 to ST15 are the same as those explained in above-mentioned Embodiments 1 and 2 with reference to FIGS. 5 and 7.

The display control unit 13 determines characters which the display control unit will display on the just previously selected character input button and each of the character input buttons other than this just previously selected character input button, respectively (step ST4-1). The characters which the display control unit has determined in this step are highlighted, in step ST5, on the character input buttons, respectively. A concrete process of determining the characters which the display control unit will display on the character input buttons respectively is done as follows.

(1) a Character Input Button Other than the Just Previously Selected Character Input Button (prev_key)

First, an operation unit 12 determines whether or not each of the characters assigned to each of the character input buttons other than the just previously selected character input button is included in the candidate characters in order starting from the character having an index=0 in a correspondence list as shown in FIG. 10. The operation unit 12 then notifies the characters assigned to the above-mentioned character input button and included in the above-mentioned candidate characters to the display control unit 13 in increasing order of the index value.

The display control unit 13 sets the characters which are notified thereto from the operation unit 12 in the above-mentioned way as characters which are to be displayed in increasing order of the index value to the character input button other than the just previously selected character input button.

(2) The Just Previously Selected Character Input Button (prev_key)

A searching unit 14 searches through a database 4a by using a character string having up to the (len−1)-th character to specify candidate characters each of which can be inputted so as to follow the character string having up to the (len−1)-th character from facility names each including the character string having up to the (len−1)-th character and extracted from the database 4a.

The operation unit 12 then refers to the correspondence list shown in FIG. 10 on the basis of the just previously selected character input button and the character currently being displayed on the character input button to calculate the index value of the character currently being displayed on the character input button (after the first-time flow is done, the operation unit uses the index value acquired in step ST11-1).

Next, the operation unit 12 determines whether or not each character assigned to the just previously selected character input button is included in the candidate characters specified from the facility names each including the character string having up to the above-mentioned (len−1)-th character (after the first-time is done, the operation unit uses the candidate characters acquired in step ST11) in increasing order of the index value starting from that of the character currently being displayed on the just previously selected character input button. The operation unit 12 notifies each character, among the characters assigned to the above-mentioned character input button, which is included in the above-mentioned candidate characters to the display control unit 13 in increasing order of the index value.

The display control unit 13 sets the character notified thereto from the operation unit 12, as a character which is to be displayed in increasing order of the index value, to the just previously selected character input button according to this selection.

When no character assigned to each of the character input buttons other than the just previously selected character input button matches one of the candidate characters, the display control unit 13 sets the character corresponding to index=0 as the character which is to be displayed on each of the character input buttons other than the just previously selected character input button, and also sets this character input button to non-display (or tones down and displays this character input button).

Hereafter, a display example of the screen for character input 5B according to the user's character input operation will be explained.

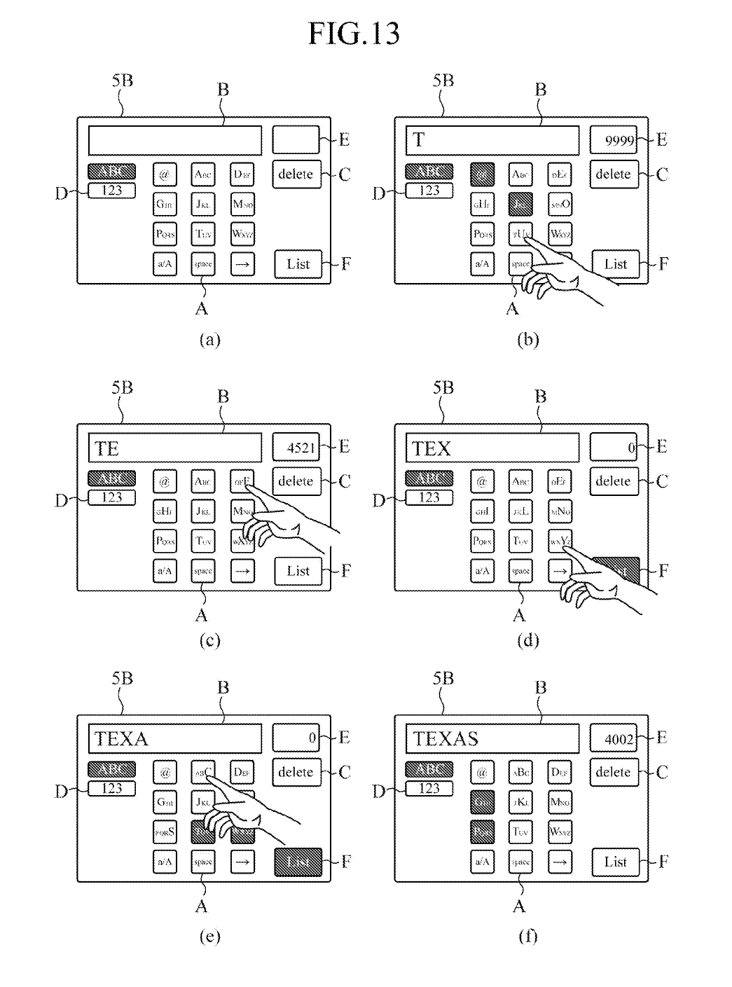

FIG. 13 is a view showing a display example of the screen for character input according to the user's character input operation on the input device in accordance with Embodiment 4. The screen for character input 5B shown in FIG. 13(a) is a one in an initial state in which the car navigation device 1 is set to a character input mode. In this example, because the car navigation device is set to the ABC mode (symbol and alphabet input mode), the twelve character input buttons including “@”, “ABC”, “DEF”, “GHI”, “JKL”, “MNO”, “PQRS”, “TUV”, “WXYZ”, “a/A”, “space”, and “→” are displayed in the character input button display area A shown in FIG. 13.

Further, a plurality of characters are assigned to each of the character input buttons including “@” to “WXYZ” according to the correspondence as shown in FIG. 10. On each of the “ABC” to “WXYZ” character input buttons, the character having the smallest index value is highlighted in a larger size than the other characters. Because the display example shown in FIG. 13(a) is the screen produced at the above-mentioned time when the input device is started for the first time, nothing is displayed in an input character string display area B and in a hit number display area E.

The user performs a character input by performing a touch operation on a touch panel (input specifying device 8) to select a character input button to which a character which the user desires to input is assigned.

A case in which the user desires to input “TEXAS” in a state in which the screen shown in FIG. 13(a) is displayed will be explained below.

First, the user selects the “TUV” character input button on which the character “T” is highlighted on the screen for character input 5B shown in FIG. 13(a). As a result, the character “T” is displayed at the head (left end) of the input character string display area B, as shown in FIG. 13(b). At this time, on each of the character input buttons other than the “TUV” character input button in the character input button display area A, each character, among the characters assigned to the character input button, which is included in the candidate characters each of which can be inputted so as to follow “T” is highlighted in increasing order of the index value.

For example, in the case of the “DEF” character input button, when the candidate characters each of which can be inputted so as to follow “T” are “E” and “F”, “E” (index=1) having the smallest index value is highlighted on the character input button according to the correspondence list shown in FIG. 10.

In contrast, in the case of the “TUV” character input button which is selected this time, the input device needs to allow a selection of either one of “U” and “V”, as well as “T”. Therefore, on the “TUV” character input button which is selected this time, not one of the candidate characters each of which can be inputted so as to follow the character “T”, but a character included in the candidate character each of which can be inputted so as to follow the character string in which the last character of the character string being inputted and currently being displayed in the input character string display area B is deleted, i.e. the (len−1)-th character of the character string being inputted, and having the smallest index value is highlighted on the character input button.

Because when only the character “T” is inputted first, a null character string is acquired by subtracting one from the input character string length len, “U” having the smallest one of the index values of the characters succeeding “T” is set as a character highlighted instead of “T”, as shown in FIG. 13(b).

The input device tones down and displays all character input buttons to each of which no character included in the candidate characters each of which can be inputted so as to follow the character “T” is assigned (see the “@” button and the “JKL” button shown in FIG. 13(b)).

When the user then selects the “DEF” character input button on which the character “E” is highlighted in the state in which the screen of FIG. 13(b) is displayed, the character “E” is inputted just as it is, and “TE” is displayed in the input character string display area B, as shown in FIG. 13(c).

At this time, on each character input button other than the “DEF” character input button which is selected this time, the character included in the candidate characters each of which can be inputted so as to follow “TE” and having the smallest index value is highlighted. For example, when the following three characters: “X”, “Y” and “Z” are specified for the “WXYZ” character input button as the candidate characters each of which can be inputted so as to follow the character string being inputted “TE”, “X” having the smallest index value is highlighted on the “WXYZ” button, as shown in FIG. 13(c).

In contrast, in the case of the “DEF” character input button which is selected this time, the input device needs to allow a selection of the candidate character “F” which can be inputted so as to follow the character “T” which has been inputted until the last time, instead of the character “E” which is inputted this time.

Therefore, on the “DEF” character input button which is selected this time, not one of the candidate characters each of which can be inputted so as to follow the character string being inputted “TE”, but the character “F” included in the candidate characters each of which can be inputted so as to follow the (len−1)-th character “T” of the character string being inputted and having the smallest index value is highlighted (refer to FIG. 13(c)).

When the user then selects the “WXYZ” character input button on which the character “X” is highlighted in the state in which the screen of FIG. 13(c) is displayed, the character “X” is inputted just as it is, and “TEX” is displayed in the input character string display area B, as shown in FIG. 13(d).

At this time, on each character input button other than the “WXYZ” character input button, the character included in the candidate characters each of which can be inputted so as to follow “TEX” and having the smallest index value is highlighted. For example, when the following two characters: “A” and “C” are specified for the “ABC” character input button as the candidate characters each of which can be inputted so as to follow the character string being inputted “TEX”, “A” having the smallest index value is highlighted on the “ABC” character input button, as shown in FIG. 13(d).

In contrast, in the case of the “WXYZ” character input button which is selected this time, the input device needs to allow a selection of the candidate character “Y” which can be inputted so as to follow the character string “TE” which has been inputted until the last time, instead of the character “X” which is inputted this time.

Therefore, on the “WXYZ” character input button which is selected this time, the character “Y” included in the candidate characters each of which can be inputted so as to follow the (len−1)-th character “TE” of the character string being inputted and having the smallest index value is highlighted.

When the user selects the “ABC” character input button on which the character “A” is highlighted in the state in which the screen of FIG. 13(d) is displayed, the character “A” is inputted just as it is, and “TEXA” is displayed in the input character string display area B, as shown in FIG. 13(e).

At this time, on each character input button other than the “ABC” character input button, the character included in the candidate characters each of which can be inputted so as to follow “TEXA” and having the smallest index value is highlighted. For example, when only “S” is specified for the “PQRS” character input button as the candidate characters each of which can be inputted so as to follow the character string being inputted “TEXA”, “S” is highlighted on the “PQRS” character input button, as shown in FIG. 13(e).

In contrast, in the case of the “ABC” character input button which is selected this time, the input device needs to allow a selection of the candidate character “C” which can be inputted so as to follow the character string “TEX” which has been inputted until the last time, instead of the character “A” which is inputted this time.

Therefore, on the “ABC” character input button which is selected this time, the character “C” included in the candidate characters each of which can be inputted so as to follow the (len−1)-th character “TEX” of the character string being inputted and having the smallest index value is highlighted, as shown in FIG. 13(e).

By finally selecting the “PQRS” character input button on which the character “S” is highlighted in the state in which the screen shown in FIG. 13(e) is displayed, the user can input “TEXAS” to the input device.

When no character assigned to a character input button is included in the candidate characters, this character input button is toned down and displayed (refer to FIG. 13(b), 13(e) or 13(f)).

The ID information of the character input button which is toned down and displayed is notified from the display control unit 13 to the operation unit 12. The operation unit 12 does not accept any selection operation of selecting the character input button which is toned down and displayed by specifying the character input button according to the ID information notified thereto from the display control unit 13. The operation unit continues this selection disable mode until receiving a notification showing that the display control unit 13 has released the toning down display and returned to a normal display (the ID information of the character input button for which the toning down display has been released) from the display control unit 13.

As mentioned above, in accordance with this Embodiment 4, the display control unit 13 displays only a character, among the plurality of characters assigned to each character input button, which is included in the candidate characters specified by the searching unit 14 on the character input button. In this structure, the display control unit 13 displays a character, among the plurality of characters assigned to each character input button, which is included in the candidate characters specified by the searching unit 14 on the character input button in increasing order of the number of times that a selection operation is needed for the specification (i.e. in increasing order of the index value). By doing in this way, the present embodiment can provide the same advantages as those provided by above-mentioned Embodiment 2 also in the case of an input of English.

Further, in above-mentioned Embodiments 3 and 4, when a character to be inputted which is specified to follow the character or the character string being inputted and currently being displayed in the input character string display area B is included in the candidate characters specified by the searching unit 14, the display control unit 13 switches between the process of toning down and displaying the character to be inputted immediately after the character or the character string being inputted in the input character string display area B (i.e. the display process in accordance with Embodiment 3), and the process of highlighting only a character, among the plurality of characters assigned to each character input button, which is included in the candidate characters specified by the searching unit 14 on the character input button (i.e. the display process in accordance with Embodiment 4) according to the time required for the user to perform a selection operation of selecting a character input button, which is detected by the operation unit 12 (the time required for the user to push down a character input button).

For example, when the time required for the user to perform a selection operation of selecting a character input button once exceeds a predetermined time, the display control unit can accept specification of only a character, among the plurality of characters assigned to the character input button, which is included in the candidate characters specified by the searching unit 14, like that in accordance with above-mentioned Embodiment 4, whereas when the time required for the user to perform a selection operation of selecting a character input button once is equal to or shorter than the predetermined time, the display control unit can accept specification of any one of all the characters assigned to the character input button, like that in accordance with above-mentioned Embodiment 3.

By thus switching between the input process in accordance with above-mentioned Embodiment 3 and that in accordance with above-mentioned Embodiment 4 through the simple selection operation, the input device can provide both of the advantages provided by above-mentioned Embodiments 3 and 4.

Although in above-mentioned Embodiments 3 and 4, the case in which the input device enables the user to input an English word by using a symbol and alphabetic character input method is shown, the input device also enables the user to similarly input a word even in the case of using a pinyin input method for Chinese or in the case of using a button structure in which a plurality of characters (symbols and alphabetic characters) needed for input are assigned to each character input button for input of a word in a European language, e.g. German.

### INDUSTRIAL APPLICABILITY

Because the input device in accordance with the present invention can facilitate a character input operation on an S/W keyboard in which a plurality of characters are assigned to each of buttons for character input, and switching among the plurality of characters assigned to each button in order is done in such away that each of them is displayed in the order while being selectable by the user every time when the button is selected, the input device in accordance with the present invention is suitable for use as an input device mounted in a mobile information terminal or a car navigation device having a relatively small display screen.

1-10. (canceled)

11. An input device provided with a storage unit for storing a database in which a plurality of words are registered, for inputting said words read from said database, said input device comprising:
a display unit for displaying a screen for character input including a plurality of character input buttons to each of which a plurality of characters are assigned, and each of which specifies one of the characters assigned thereto, as a character to be inputted, according to a number of times that a selection operation is performed thereon, and an input character string display area in which a character to be inputted which is specified through a selection operation performed on said plurality of character input buttons is displayed in order;
an operation unit for performing a selection operation on said plurality of character input buttons;
a searching unit for searching through said database stored in said storage unit on a basis of a character or a character string being inputted and displayed in said input character string display area to extract character strings of words each including said character or said character string being inputted, and for specifying candidate characters each of which can be inputted so as to follow said character or said character string being inputted from said extracted character strings; and
a display control unit for controlling a display operation of said display unit, and, when a character to be inputted which is specified to follow the character or the character string being inputted and displayed in said input character string display area is not included in the candidate characters specified by said searching unit, toning down and displaying said character to be inputted immediately after the character or the character string being inputted and displayed in said input character string display area.

12. The input device according to claim 11, wherein said display control unit displays a hit number display area in which a hit number showing a number of hits of a word including said character to be inputted which is specified to follow the character or the character string being inputted and displayed in said input character string display area is displayed on said screen for character input, and, when the character to be inputted which is specified to follow the character or the character string being inputted and displayed in said input character string display area is not included in the candidate characters specified by said searching unit, tones down and displays said character to be inputted immediately after the character or the character string being inputted and displayed in said input character string display area, and also displays that there is no hit number in said hit number display area.

13. The input device according to claim 11, wherein when the character to be inputted which is specified to follow the character or the character string being inputted and displayed in said input character string display area is not included in the candidate characters specified by said searching unit, said display control unit usually displays a character input button to which said character to be inputted is assigned, and also tones down and displays character input buttons other than said character input button.

14. The input device according to claim 13, wherein said operation unit does not accept a selection operation of selecting said character input button which is toned down and displayed.

15. The input device according to claim 11, wherein said input device includes a sound output unit for outputting an operation sound according to an operation on said operation unit, and said sound output unit outputs an operation sound which differs according to whether or not the character to be inputted which is specified to follow said character or said character string being inputted and displayed in said input character string display area is included in the candidate characters specified by said searching unit.

16. The input device according to claim 11, wherein said input device includes a vibrating device unit which vibrates according to an operation performed on said operation unit, and said vibrating device unit vibrates with a vibration amount or at a vibration frequency, said vibration amount and said vibration frequency differing according to whether or not the character to be inputted which is specified to follow said character or said character string being inputted and displayed in said input character string display area is included in the candidate characters specified by said searching unit.

17. An input device provided with a storage unit for storing a database in which a plurality of words are registered, for inputting said words read from said database, said input device comprising:
a display device for displaying a screen for character input including a plurality of character input buttons to each of which a plurality of characters are assigned, for specifying, as a character to be inputted, a character according to a number of times that a selection operation is performed, and an input character string display area in which a character to be inputted which is specified through a selection operation performed on said plurality of character input buttons is displayed in order;
an operation unit for performing a selection operation on said plurality of character input buttons;
a searching unit for searching through said database stored in said storage unit on a basis of a character or a character string being inputted and displayed in said input character string display area to extract character strings of words each including said character or said character string being inputted, and for specifying candidate characters each of which can be inputted so as to follow said character or said character string being inputted from said extracted character strings; and
a display control unit for controlling a display operation of said display device, wherein
said display control unit switches between a process of, when a character to be inputted which is specified to follow the character or the character string being inputted and displayed in said input character string display area is not included in the candidate characters specified by said searching unit, toning down and displaying said character to be inputted immediately after the character or the character string being inputted and displayed in said input character string display area, and a process of displaying only a character, among the plurality of characters assigned to each of said character input buttons, which is included in the candidate characters specified by said searching unit on said each character input button according to a time required to perform the selection operation on said plurality of character input buttons, which is detected by said operation unit.
